(19) United States
(12) Patent Application Publication
(10) Pub. No.: US 2023/0275877 A1
(43) Pub. Date: Aug. 31, 2023

(54) VISUAL SENSOR VALIDATION SYSTEM

(71) Applicant: KARAMBA SECURITY LTD., Hod Hasharon (IL)

(72) Inventors: Assaf HAREL, Ramat Hasharon (IL); Amiram DOTAN, Birmingham, MI (US); David BARZILAI, Hod Hasharon (IL); Eli MORDECHAI, Modiin (IL); Tal Efraim BEN DAVID, Hogla (IL)

(21) Appl. No.: 17/278,482

(22) PCT Filed: Sep. 24, 2019
(86) PCT No.: PCT/US2019/052692

§ 371 Date: Mar. 22, 2021

Related U.S. Application Data
(63) Continuation-in-part of application No. 16/140,144, filed on Sep. 24, 2018, now Pat. No. 10,419,408.
(60) Provisional application No. 62/735,647, filed on Sep. 24, 2018.
(60) Provisional application No. 62/752,111, filed on Oct. 29, 2018.

(51) Int. Cl. H04L 9/40; H04L 9/06; H04L 12/40; G09C 1/00; G06F 21/53

(52) U.S. Cl. CPC H04L 63/0428; H04L 63/12; H04L 9/0643; H04L 12/40; G09C 1/00; G06F 21/53; H04L 63/08; H04L 67/12

(57) ABSTRACT

Technology descried here can be used for collecting information about malicious attacks on computer devices. Hosting hardware can be configured to host virtual machines, virtual machines of ECU images, and ECUs to collect records of malicious attacks. An attack analyzer can generate fingerprints from the malicious attacks.

### PRIORITY INFORMATION

This application claims priority to U.S. Provisional Application Ser. No. 62/735,647, filed on Sep. 24, 2018, U.S. Provisional Application Ser. No. 62,752,111, filed on Oct. 29, 2018, and U.S. patent application Ser. No. 16/140,144, filed on Sep. 24, 2018.

### TECHNICAL FIELD

This specification generally relates to computer memory security in Automotive Control Units (ECUs) and other electronic controllers, verification of driving assistance database information, and Internet of Things (IoT) network security.

### BACKGROUND

Electronic controllers are computer systems with a dedicated function within a larger mechanical or electrical system. Electronic controllers are often physically embedded with the larger systems that they control, though this is not always the case. Electronic controllers often have one or more processor, and sometimes have computer memory that holds instructions for the processors. Electronic controllers can read sensor information and/or send commands to elements of the system in order to cause the system to perform some task.

One type of electronic controller is known as electronic control units (ECUs.) ECUs are embedded systems in automobiles or other devices. The ECUs control the electrical systems and/or other subsystems in the vehicle. Many ECUs include a processor and memory with instructions for the processor. ECUs in a vehicle often communicate over a bus called the Controller Area Network (CAN) bus.

Originally, ECUs had little or no general-purpose interface with public networks like the Internet. However, as computing technology and infrastructure evolved, the networking capacity of ECUs has also advanced. Now, some automobiles have ECUs with data communication features that allow for connections to public networks like the Internet.

The Internet is a global system of interconnected computer networks that use the Internet protocol suite (for example, TCP/IP) to link devices worldwide. The internet has been called a “network of networks” and has been used to connect private, public, academic, business, and government networks. Data passed over these networks includes a vast array of information resources and services, such as hypertext document, applications, electronic mail, telephony, and file sharing.

In related aspects, the information in driving assistance databases typically comes from a number of sources. Some information comes from government and private geographic information systems (GIS) (e.g., maps). Some information comes from government transportation departments or similar entities (e.g., temporary road/bridge closures, detours). Some information comes from explicit data collection efforts (e.g., “street-view” cars sponsored by mapping companies and configured to collect road information by being driven around in the real world).

Driving assistance databases have become vital to contemporary transportation includes autonomous transportation. Portable and integrated electronic driving assistance systems can be found in a large number of vehicles on the roads today. Such devices provide drivers or systems with a flexible and convenient source of information about the road environment, such as addresses, navigation information, traffic sign location and road condition. The usefulness of such information, however, is limited based on the accuracy of the information.

As partly and fully autonomous vehicle navigation systems (e.g., self-driving cars and trucks) grow in availability and popularity, the need for accurate information grows as well. Without having accurate and up-to-date information available, systems that use such information may exhibit unexpected or unwanted performance.

In other related aspects, Cyber-attacks come in many forms and flavors, but they generally share the same basic concepts: find a preexisting security bug (vulnerability) in a system or a network, exploit it, and perform malicious actions (e.g., running malware, eavesdropping on communications, spoofing the identity of others). For example, network packets that are broadcast to network participants without any sort of cryptography (or other mechanism to hide/obfuscate the message contents) are susceptible to eavesdropping by other entities on the network. In another example, network communication that uses a common transmission medium (e.g., a bus) to broadcast messages among network participants can be susceptible to network participants spoofing the identity of others on the network (e.g., transmitting messages with the sender field having been modified so that the messages appear to originate from another device on the network). Verifying that the sender of a message is authentic, particularly when the message is broadcast over a network (e.g., a bus) such that the true identity of the sender is not readily decipherable from the message's transmission path, is a challenge and a security vulnerability for controllers.

### SUMMARY

This document generally describes a technological solution that can be used to strengthen the cyber security capabilities of a device controllers such as ECUs to be protected against cyber security attacks (sometimes referred to as cybersecurity hardening), even before those controllers are fully finalized. Beginning with the development specifications for a controller, so-called “trap images” are made accessible on the public Internet. These trap image are designed with libraries that are specified for use in an as-of-yet undeveloped controller. Data communications with the trap images are monitored to identify possible malicious attacks, and those attacks may then be monitored. Sometimes, such a setup is referred to as a “honeypot.”

Information from the malicious attacks can be recorded and attack fingerprints (sometimes referred to as Indications of Compromise (IOCs)) can be created based on elements of the attack. These fingerprints or IOCs can include, for example, a bit-signature, a command-and-control address, geographic or URL source of the attack, etc.

Once an image for the ECU has been developed, possibly with insights gained from the early attack fingerprints, that image can be hosted in virtual machines and again exposed to network traffic and thus malicious attacks. Again, attack fingerprints are generated based on analysis of the attacks.

Later, when physical ECUs are developed, those can be connected to the Internet again as honeypots. Again, malicious attacks can be observed, and attack fingerprints again generated. These fingerprints may be used for security purposes for the physical ECUs that are in production and use. For example, these fingerprints can be consumed by a network Intrusion Prevention System (IPS) at the Internet Service Provider (ISP) or cellular communication provider for the vehicle fleet, and thus block malicious cyber security attack attempts that were originally identified on the honeypot network. In another example these fingerprints can be consumed by an Intrusion Prevention System (IPS) on the device itself (that is being decoyed) or on another in-vehicle cybersecurity system, that will block the malicious cyber security attack attempts that were originally identified on the honeypot network.

This document also describes systems and techniques for maintaining an updated database of road information (e.g., signs, locations) and for using such a database to verify sensor-based detections of road information, such as through sensors that are incorporated into vehicles. For example, automobiles may access one or more databases of road information as they are driving in order to alert drivers as to various road features (e.g., speed limit, sharp turn, upcoming traffic signal, stop sign), and/or may leverage such road information to provide autonomous or semi-autonomous driving features. However, road information may change overtime. For example, the speed limit on a road may change over time (e.g., speed limit increases, speed limit decreases), but databases of road information may be slow to identify and incorporate such changes. Automobiles using outdated road information may pose a safety risk to passengers in the vehicles, other vehicles, and to people in the surrounding environment (e.g., pedestrians). The technology described in this document provides mechanisms for road information to be dynamically updated via automobile sensor readings, and also for such sensor readings to be verified in order to validate the road information that the sensors have detected. Such features can provide for improved safety and data integrity associated with road information.

This document further describes a technological solution that provide improved network security for communication among externally connected controllers (e.g., ECUs) within an IoT device (e.g., connected automobile), which can protect against any of a variety of malware attacks and/or other cyber security threats. Improved network security can be provided through any of a variety of mechanisms, such as through improved cryptographic engines and processes that more effectively and efficiently obfuscate network traffic from unintended recipients, and that provide for more accurate and reliable techniques for validating communication as having emanated from a particular sender. For example, improved cryptographic engines and processes can provide in-place cryptography and authentication of network communication that does not add any network overhead (e.g., “zero overhead”—“meaning no bits of extra data added to network messages to authenticate encoded messages). Furthermore, improved cryptographic engines and processes can have a low performance impact on controllers encoding and authenticating messages on a network—providing robust, resilient, and efficient network security that has a minimal impact on controller and network performance. Additional and/or alternative features can also be used to provide improved cryptographic engines and processes for secure communication among nodes on a network, such as ECU s communicating with each other over a CAN bus or similar networks. While improved cryptographic engines are described throughout this document with regard to ECU s connected to each other over a CAN bus, they are provided as illustrative examples of technical environments in which the improved cryptographic engines can be implemented. The improved cryptographic engines, for example, can be implemented on any of a variety of different networks and nodes (e.g., controllers, communicatively connected devices, and/or other network components).

In one implementation, a system can be used for collecting information about malicious attacks on computer devices. The system include hosting hardware that is configured to, in a first time: host one or more first virtual machines, each of the virtual machines comprising one or more first libraries identified by specifications for an electronic control unit (ECU); expose the first virtual machines to a data network such that malicious attacks against the first virtual machines are possible over the data network; generate first records of the malicious attacks against the first virtual machines; in a second time after the first time: host one or more second virtual machines, each of the second virtual machines comprising an ECU image that comprise second libraries; expose the second virtual machines to the data network such that malicious attacks against the second virtual machines are possible over the data network; and generate second records of the malicious attacks against the second virtual machines. The system further includes an attack analyzer configured to: in the first time, generate first attack fingerprints using the first records; and in the second time, generate second attack fingerprints using the second records. Methods, devices, and computer-readable implementations, as well as other systems with some or all of these features are also described.

Implementations can include none, one, some, or all of the following features. The hosting hardware is further configured to, in a third time after the second time expose physical ECUs to the data network such that malicious attacks against the physical ECUs are possible over the data network; and generate third records of the malicious attacks against the physical ECUs; and the attack analyzer is further configured to in the third time, generate third attack fingerprints using the third records. The attack analyzer is further configured to: in the first time, provide the first attack fingerprints to a developer of the ECU image; in the second time, provide the second attack fingerprints to a developer of the physical ECU; and In the third time, provide the third attack fingerprints to a security manager of an automobile using a physical ECU. The ECU image has been developed to minimize a security flaw based on the providing of the first attack fingerprints to the developer of the ECU image. The physical ECU is configured to prevent a malicious attack based on the third attack fingerprints. The system further comprising an automotive manager configured to: receive the third attack fingerprints; and provide to an ECU in an automobile an update based on the third attack fingerprints, the update configured to harden the ECU in the automobile against an attacks. The at least one of the first libraries is not included in the second libraries. At least one of the second libraries is not in the first libraries.

Certain implementations can provide one or more of the following advantages. For example, the technology of device security can be improved. Security improvement can be advantageously be designed early in the development lifecycle of a device, resulting in a more secure device. The system can be used to probe for different attack vectors from different geographies and platforms, so that a wide variety of information can be gathered. Iterative version of a device can be deployed quickly and easily using the same framework, allowing for testing that is more robust. Different attacks sources can be found through the use of this technology.

Consistent with the present embodiments, a method for detecting and blocking potential attacks to vehicle ECUs based on a geographically distributed ECU trap network is disclosed. The method may include communicating with a plurality of trap network devices distributed geographically in two or more locations, the plurality of trap network devices being configured to simulate one or more vehicle-based network devices; receiving, from the plurality of trap network devices, attack information identifying a plurality of potential attacks on the plurality of trap network devices; analyzing the received attack information to identify an attack fingerprint associated with at least one of the plurality of potential attacks; and automatically sending a security update from a server remote from a vehicle to at least one of: the vehicle or a reporting server; wherein the security update is configured to update software running on the vehicle associated with the attack fingerprint.

In some embodiments, the plurality of trap network devices are configured to simulate at least one vehicle-based ECU.

In some embodiments, the plurality of trap network devices are configured to simulate at least one vehicle-based gateway.

In some embodiments, the plurality of trap network devices are configured as a plurality of virtual machine instances to emulate a plurality of vehicle-based ECUs.

In some embodiments, the attack fingerprint is associated with a bit-signature.

In some embodiments, the attack fingerprint is associated with a command-and-control address source of the attack.

In some embodiments, the attack fingerprint is associated with a geographic source of the attack.

In some embodiments, the attack fingerprint is associated with a URL source of the attack.

In some embodiments, the attack information includes network communications addressed to a sensor in the vehicle.

In some embodiments, the method may further comprise automatically sending, to a fleet of vehicles, the security update from the server remote from the vehicle, the security update being configured to update software running on the fleet of vehicles associated with the attack fingerprint.

Consistent with other disclosed embodiments, non-transitory computer readable storage media may store program instructions, which are executed by at least one processor device and perform any of the methods described herein.

Consistent with other present embodiments, a method for two-factor validation for computer-assisted vehicle functions is disclosed. The method may include receiving, from a real time sensor in a vehicle, sensor data collected by the sensor during operation of the vehicle and relating to a sensed environmental characteristic; identifying a potential computer-assisted vehicle function to be performed in the vehicle based on the sensor data; accessing, before the potential computer-assisted vehicle function is allowed to occur, a source of validation information external to the vehicle, wherein the source of validation information also relates to the environmental characteristic; determining whether the sensed environmental characteristic corresponds to the validation information; and based on the determining, either: permitting the computer-assisted vehicle function to occur when the sensed environmental characteristic corresponds to the validation information or sending a report to a reporting service when the sensed environmental characteristic does not correspond to the validation information.

In some embodiments, the sensed environmental characteristic is a detected object.

In some embodiments, the sensed environmental characteristic is a detected road sign.

In some embodiments, the sensed environmental characteristic is a detected landmark.

In some embodiments, the sensed environmental characteristic is a speed limit associated with GPS information associated with the vehicle.

In some embodiments, the sensed environmental characteristic is a color of a traffic signal.

In some embodiments, the potential computer-assisted vehicle function is braking the vehicle.

In some embodiments, the source of authentication information is a map database.

In some embodiments, the report is configured to update a confidence parameter associated with the potential computer-assisted vehicle function.

In some embodiments, the report is configured to update a confidence parameter associated with the source of validation information.

Consistent with other disclosed embodiments, non-transitory computer readable storage media may store program instructions, which are executed by at least one processor device and perform any of the methods described herein.

Consistent with other present embodiments, a system to authenticate communication over an in-vehicle communications network using in-place cryptography and authentication to more effectively and efficiently obfuscate network traffic from unintended recipients is disclosed. The system may comprise an in-vehicle communications network comprising a first ECU and a second ECU, wherein the first ECU is configured to transmit messages of a particular type over the in-vehicle communications network using in-place cryptography and authentication that replaces cleartext in the messages with the ciphertext that does not include any additional bits of information, and wherein the second ECU is configured to listen for the messages of the particular type transmitted over the in-vehicle communications network and to authenticate the messages as having originated from the first ECU based on the ciphertext, the second ECU being loaded with a predetermined model for the particular type of message that identifies one or more redundancies in the messages, the authentication including transforming the ciphertext into the cleartext and verifying the first ECU as the source of the messages by identifying the one or more redundancies in the cleartext.

In some embodiments, the predetermined model is generated in a secure environment using analysis of the first ECU and the cleartext in the messages of the particular type that are transmitted by the first ECU over the in-vehicle communications network

In some embodiments, the analysis includes one or more of static analysis, dynamic analysis, and machine learning.

In some embodiments, the predetermined model identifies particular bits in the cleartext for messages of the particular type that provide the one or more redundancies and corresponding predictable values for the particular bits.

In some embodiments, the predetermined model further identifies the particular bits based on previous messages in a sequence of messages of the particular type that have been received from the first ECU.

In some embodiments, the predetermined model further identifies the particular bits based on a presence of one or more patterns of values of bits in the cleartext.

In some embodiments, the second ECU generates the cleartext from the ciphertext, in part, by performing a logical operation on the ciphertext using a value derived from a counter for the messages of the particular type from the first ECU, the counter value being incremented for each message of the particular type that is transmitted over the in-vehicle communications network.

In some embodiments, the second ECU is configured to regenerate the cleartext from the ciphertext using one or more modifications in response to the one or more redundancies not being identified within the cleartext.

In some embodiments, the second ECU generates the cleartext from the ciphertext, in part, by performing a logical operation on the ciphertext using a value derived from a counter for the messages of the particular type from the first ECU, and wherein the cleartext is regenerated by modifying the value of the counter.

In some embodiments, the logical operation includes an XOR operation.

In some embodiments, the value is derived from the counter by taking a hash of the counter or applying one or more pseudo-random functions (PRF) to the counter.

In some embodiments, the counter is incremented for each instance of the cleartext being regenerated, the cleartext is regenerated a first threshold number of times, and after unsuccessfully attempting authenticate the message a second threshold number of times, the ECU discards the message.

In some embodiments, the second ECU additionally generates an alarm in response to unsuccessfully attempting to authenticate the message the second threshold number of times.

In some embodiments, the second ECU generates the alarm in response to at least a threshold number of messages from the first ECU over a period of time being unsuccessfully authenticated.

In some embodiments, the in-place cryptography performed by the first ECU on the cleartext to generate the ciphertext comprises: accessing a counter for the particular type of messages transmitted to the second ECU, generating a reproducible value from the counter, performing a logical operation on the reproducible value and the cleartext to generate a combined value, and applying one or more block ciphers to the combined value to generate the ciphertext; and the second ECU generates the cleartext from the ciphertext by performing operations comprising: applying the one or more block ciphers to the ciphertext to generate the combined value, accessing a local copy of the counter maintained on the second ECU for the particular type of messages transmitted with the first ECU, generating a local reproducible value from the local copy of the counter, and performing the logical operation on the local reproducible value and the combined value to generate the cleartext.

In some embodiments, only the ciphertext is transmitted from the first ECU to the second ECU, which is preprogrammed to use the one or more block ciphers, to maintain the local copy of the counter, to perform one or more operations to generate the local reproducible value, and to perform the logical operation.

In some embodiments, the in-vehicle communications network comprises a CAN bus.

In some embodiments, the first ECU, the second ECU, and the CAN bus are part of an automobile.

Consistent with other present embodiments, a method for to authenticate communication over an in-vehicle communications network using in-place cryptography and authentication to more effectively and efficiently obfuscate network traffic from unintended recipients is disclosed. The method may include transmitting, by a first ECU, messages of a particular type over the in-vehicle communications network using in-place cryptography and authentication that replaces cleartext in the messages with the ciphertext that does not include any additional bits of information; and listening, by a second ECU, for the messages of the particular type transmitted over the in-vehicle communications network and to authenticate the messages as having originated from the first ECU based on the ciphertext, the second ECU being loaded with a predetermined model for the particular type of message that identifies one or more redundancies in the messages, the authentication including transforming the ciphertext into the cleartext and verifying the first ECU as the source of the messages by identifying the one or more redundancies in the cleartext.

Consistent with other disclosed embodiments, non-transitory computer readable storage media may store program instructions, which are executed by at least one processor device and perform any of the methods described herein.

Additional and/or alternative advantages are also possible, as described below.

### BRIEF DESCRIPTION OF THE ATTACHMENTS

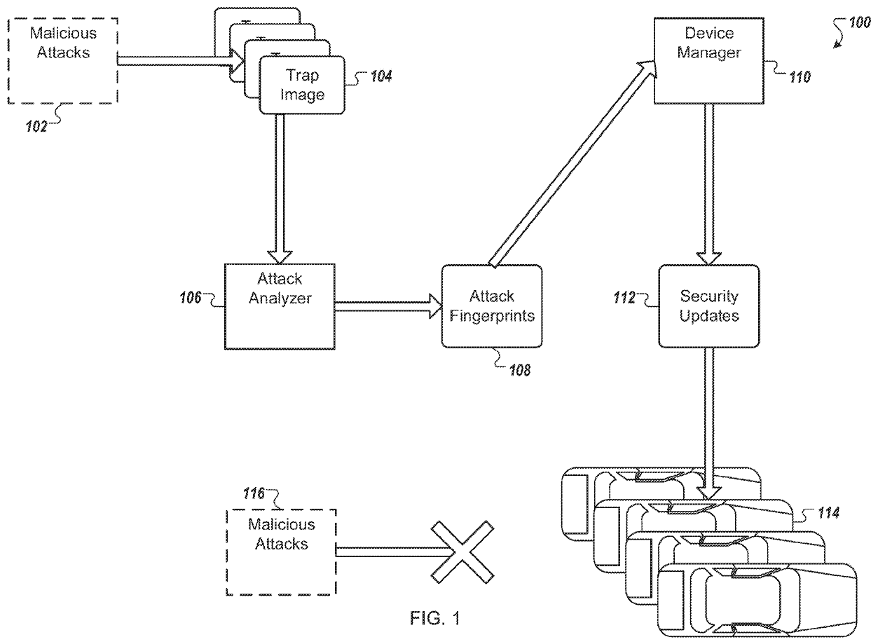

FIG. 1 block diagram of an example system for hardening electronic controller units.

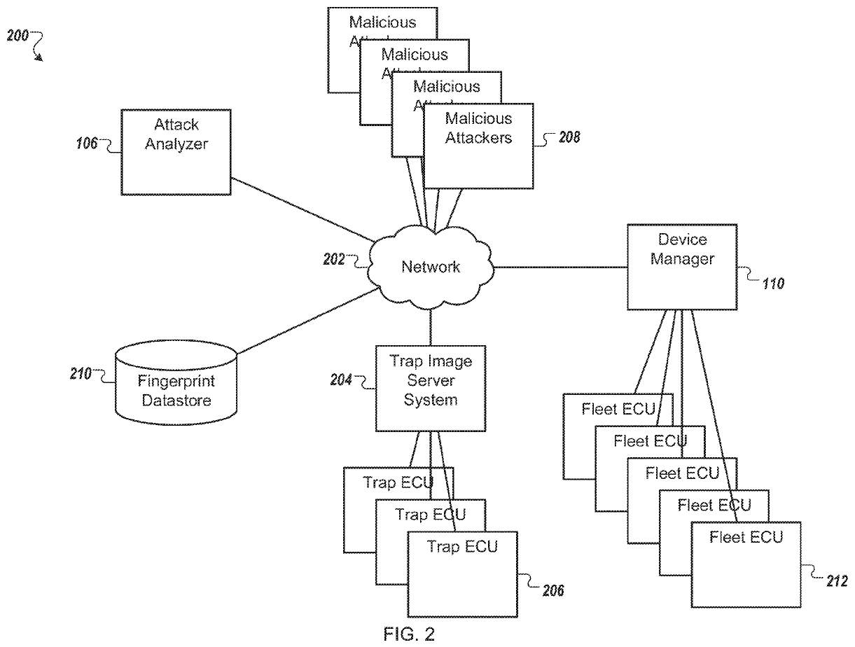

FIG. 2 is a block diagram of an example system for collecting information of malicious attacks.

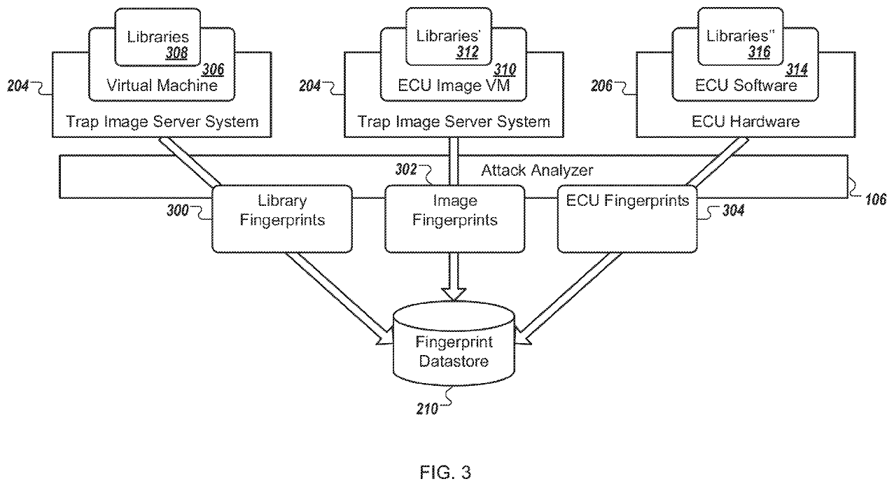

FIG. 3 is a block diagram of example systems made available over data networks.

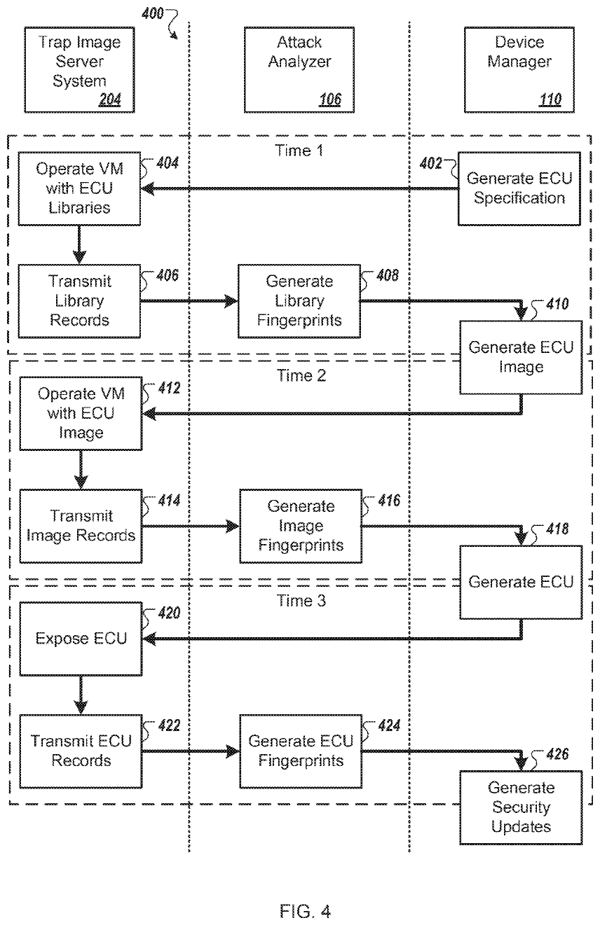

FIG. 4 is a flowchart of an example process for hardening electronic control units.

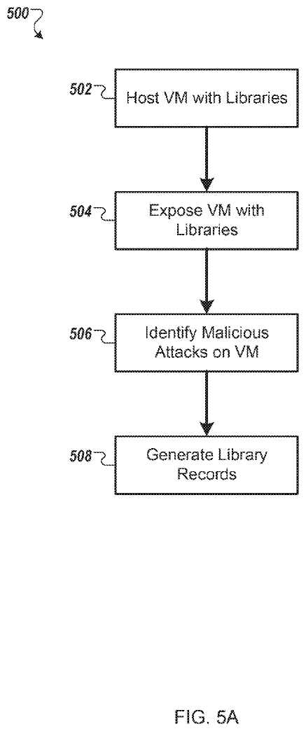

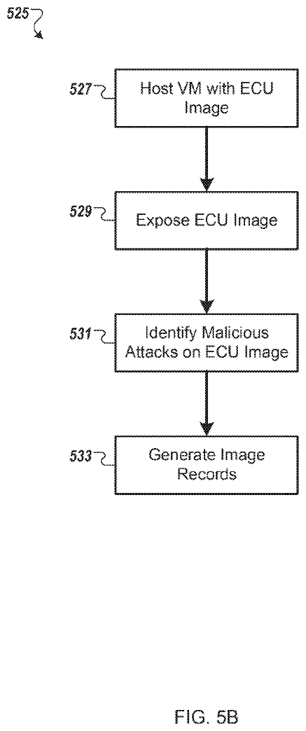

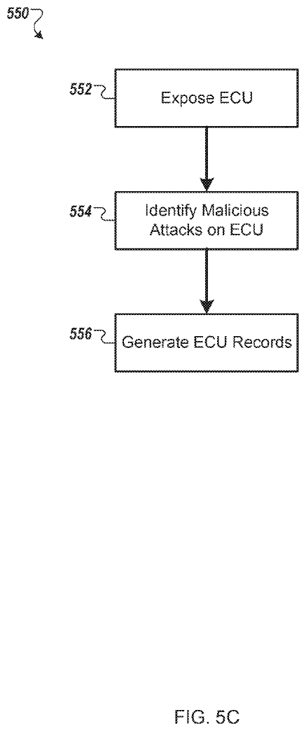

FIGS. 5A-5C are flowcharts of example processes for hosting honeypots.

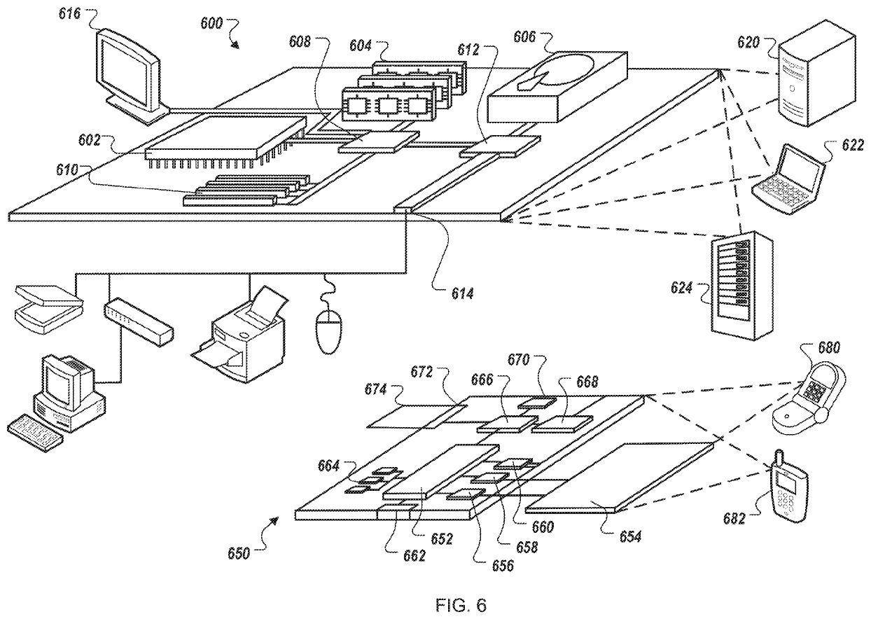

FIG. 6 is a schematic diagram that shows an example of a computing system.

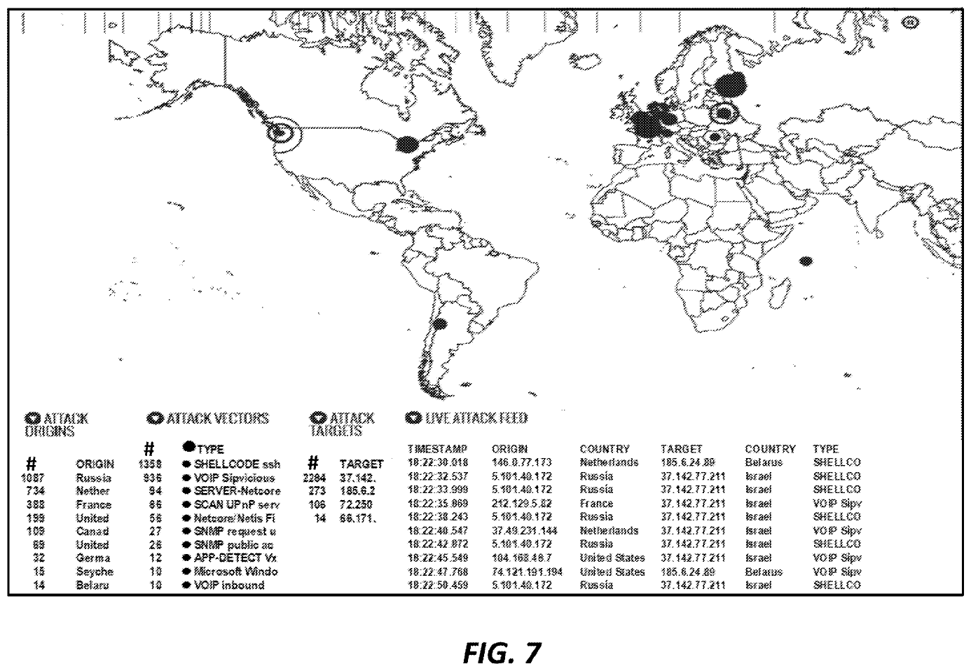

FIG. 7 is a graphic user interface (GUI) showing data produced by the technology described in this document.

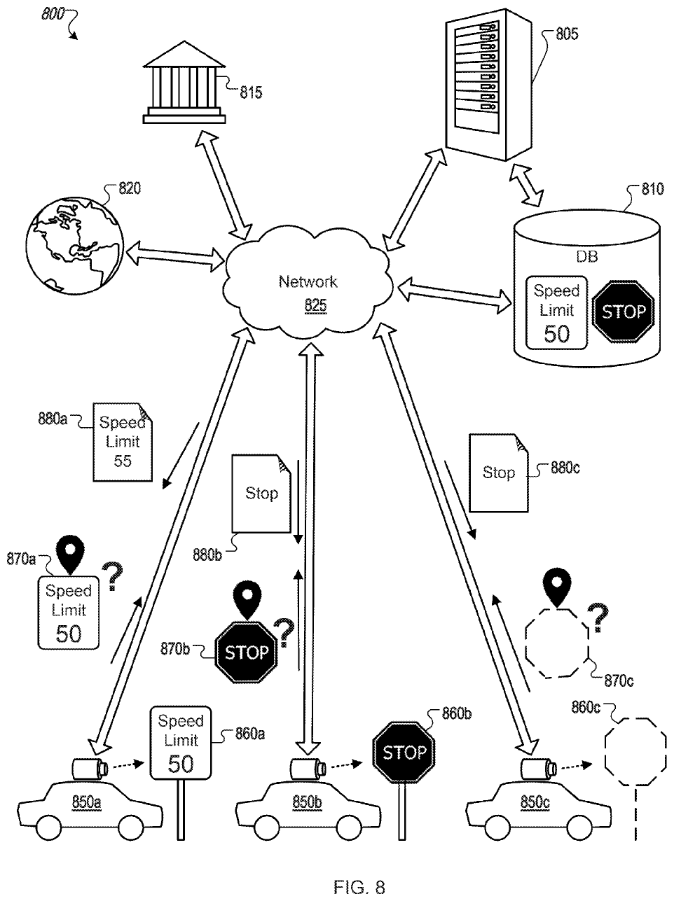

FIG. 8 is a schematic diagram that shows an example of a system for sensor validation of database information.

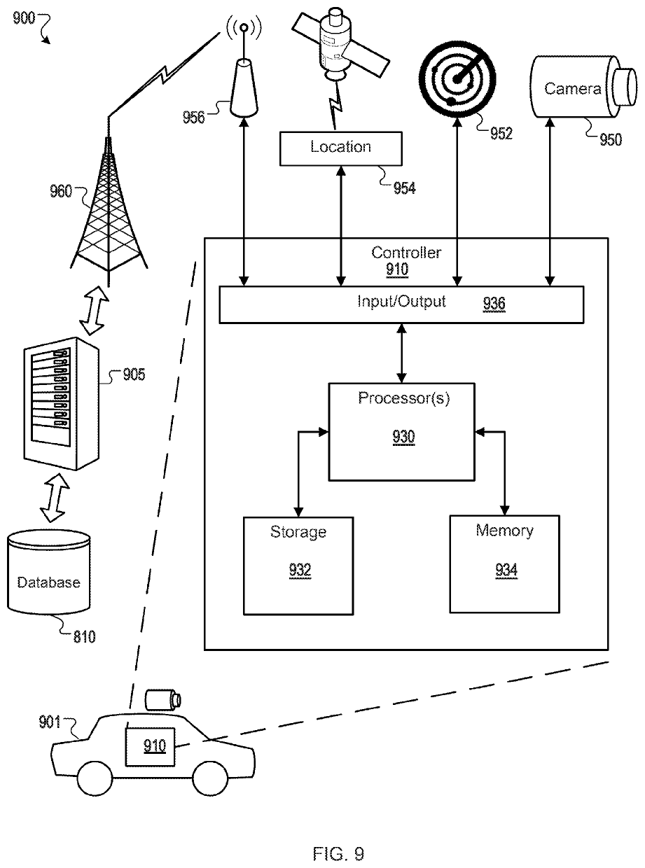

FIG. 9 is a block diagram that shows an example of a system for sensor validation of database information.

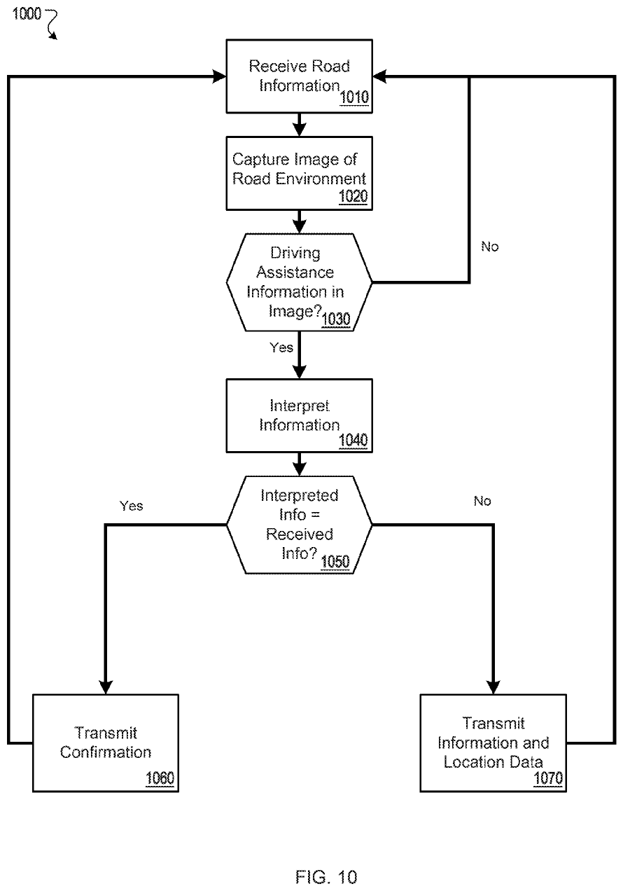

FIG. 10 is a flow chart that shows an example of a process for sensor validation of database information.

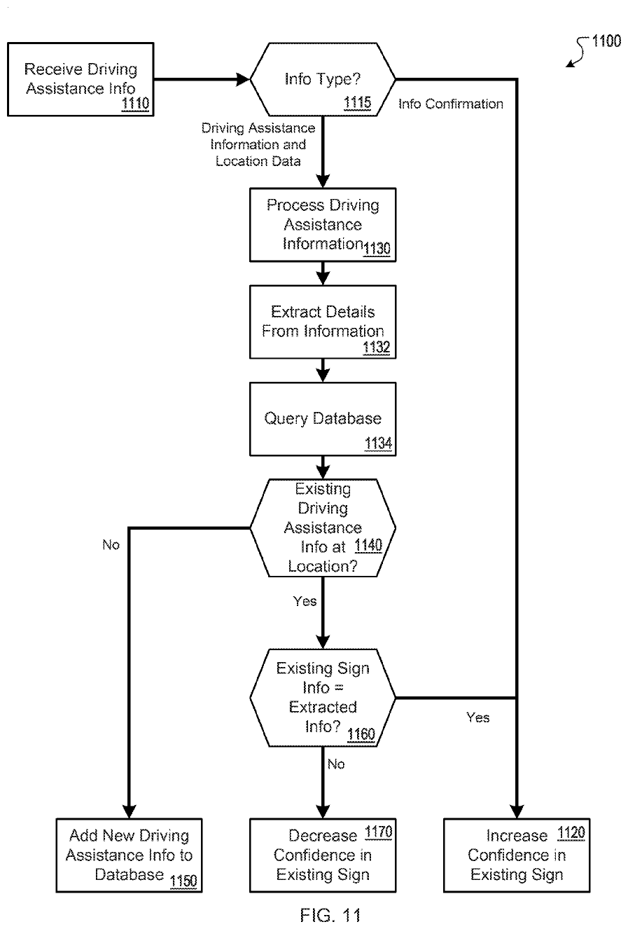

FIG. 11 is a flow chart that shows another example of a process for sensor validation of database information.

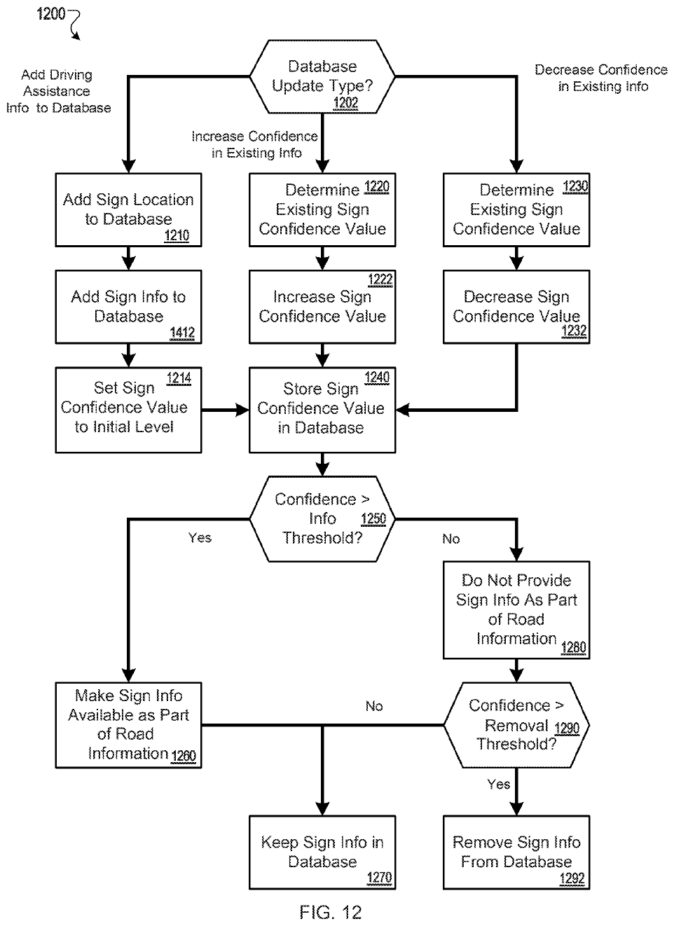

FIG. 12 is a flow chart that shows another example of a process for sensor validation of database information.

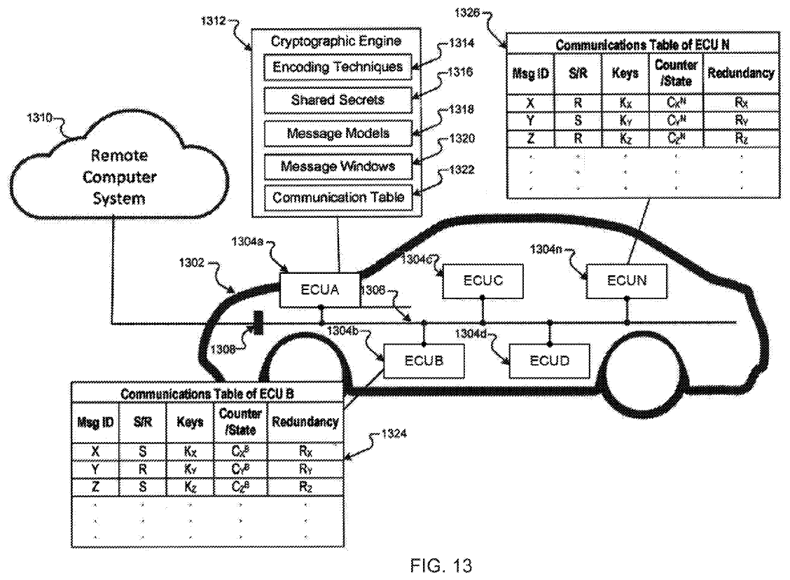

FIG. 13 is a conceptual diagram of an example system for providing low overhead network security on example ECUs that are part of an example vehicle.

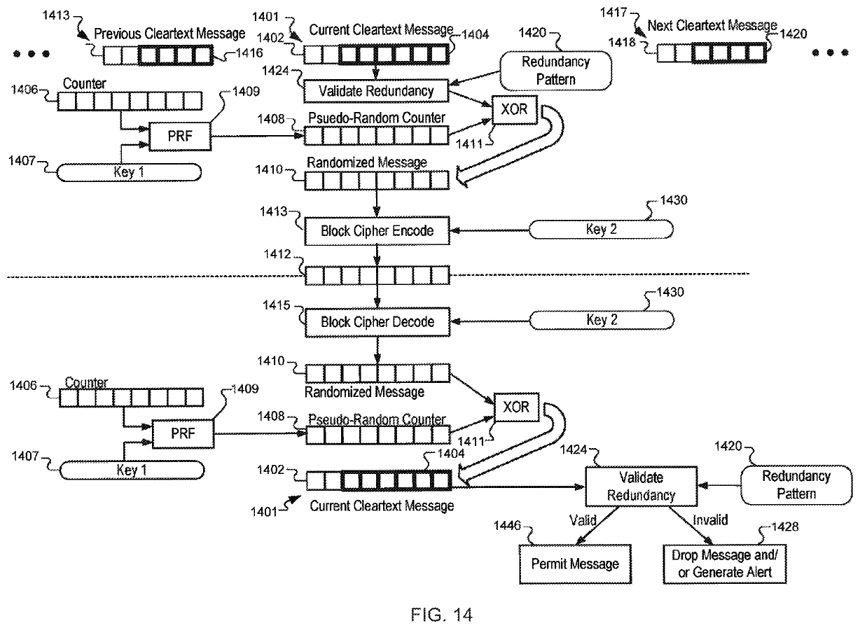

FIG. 14 is a block diagram of example data that is encoded and decoded for communication over a CAN bus.

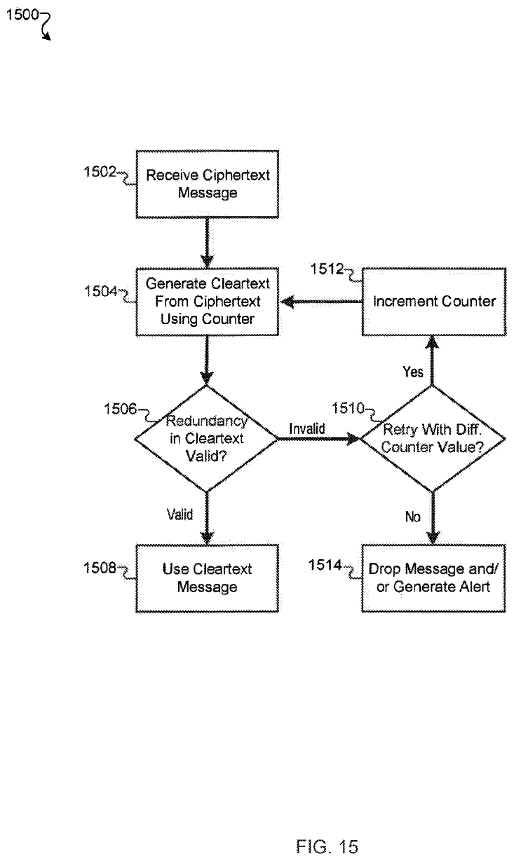

FIG. 15 is a flowchart of an example process for iteratively attempting to decode ciphertext with different counter values.

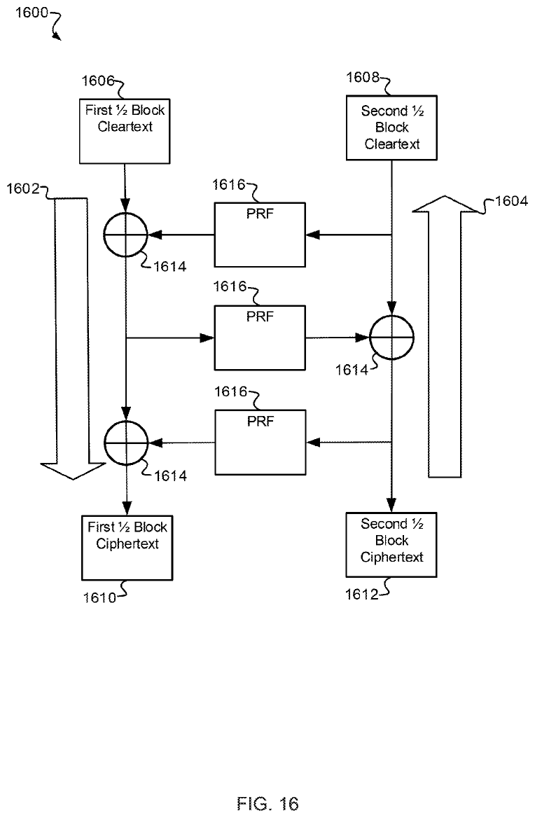

FIG. 16 is a flowchart of an example of a process for encoding and decoding data.

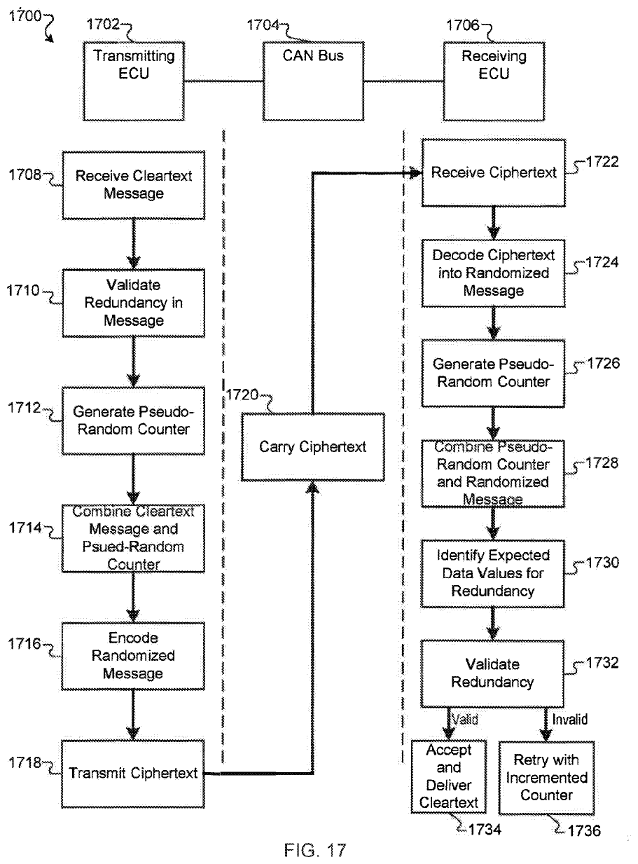

FIG. 17 is a swimlane diagram of an example process used to encode and decode data communicated over a CAN bus.

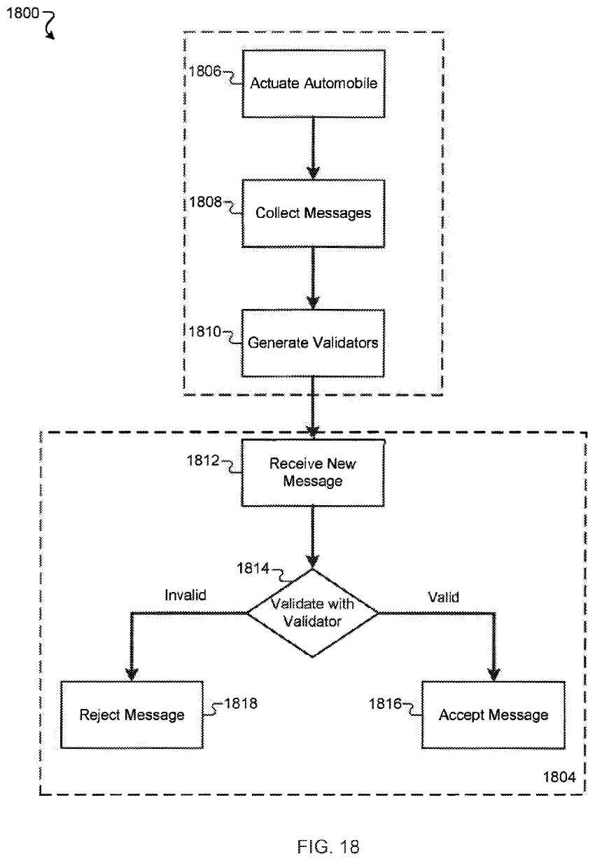

FIG. 18 is a flowchart of an example process used to validate messages.

Like reference numbers and designations in the various drawings indicate like elements.

### DETAILED DESCRIPTION

This document generally describes systems that can be used to cybersecurity harden electronic controllers even before those controllers are fully developed and deployed. As incremental advancements are made to the development of an electronic controller, honeypots matching the state of development can be placed online as a target for malicious attacks. These attacks are observed, and data generated from the observation can be used either to improve the development of the electronic controllers, or to make updates that will be pushed to electronic controllers in use.

This document also describes systems and techniques for verifying driving assistance database information. In general, this system has a cloud-based central database that is queried by vehicles that are equipped with processors and sensors (e.g., cameras, LIDAR, global positioning systems) that can sense the presence of road status information, such as road signs, road conditions, and/or other information relevant to a vehicle navigating around. The sensor information can be processed to extract the information provided by those sources of status information (e.g., signs), and the extracted information can be compared to information in the database to determine if the database needs to be updated.

For example, a city government may decide to add a “no right turn on red” sign at a particular corner, but it may take weeks or months before the local department of transportation updates its records. For manually operated vehicles, this is not a significant problem, since the human driver has the responsibility to watch for and obey traffic signs. Self-driving vehicles, however, can rely more heavily upon driving assistance database information to guide their behavior. Without the new sign of this example being promptly added to the driving assistance database, a self-driving car may remain unaware of the change and make an illegal and/or dangerous right turn on red. As will be explained below, the sensors of such vehicles can be used as part of a process to confirm, deny, update, add, and/or remove driving assistance database information based on the sensor readings of one or more vehicles.

This document also describes systems and techniques for providing network security for communication between externally connected controllers within an IoT device, such as through using a cryptographic engine.

FIG. 1 block diagram of an example system 100 for hardening electronic controller units. In the system 100, the technology described in this document is used to harden ECUs that are used in automobiles, and thus the examples described in this document will include automobiles and automobile-specific terminology (e.g., a fleet.) However, it will be understood that other types of electronic controllers can be hardened with this technology. For example, an automated device, sometimes called part of the “Internet of Things,” such as a networked light bulb or a networked garage-door-opener, could be hardened with similar technology.

In the system 100, malicious attacks 102 against trap images 104 are monitored. In general, malicious attacks generally include interactions with the trap images that are intended to control or influence the target of the attacks in some way that the owner of the target would not want. This can include causing the target to execute code, exfiltration data, becoming part of a bot-net, etc. In some cases, a malicious attack only involves gathering data which may be used, for example, in order to allow the attacker to craft a future attack. In some cases, malicious attacks are intended and encouraged by the owner. For example, malicious attacks can include testing of a system or device done at the request of the designer of the system, sometimes called “penetration testing” or “red team testing.” As another example, a so-called “honeypot,” “honey pot,” or “honey-pot,” is a system intentionally provided to act as a target for malicious attacks. In some cases, the honeypot is used to centralize attacks, reducing the time it may take to identify when an attack has started.

Here, the trap images 104 are provided as honeypots in order to gain intelligence about possible security flaws in the trap images 104. The trap images 104 are images of software of ECUs that are to be hardened. These trap images 104 may be the final software, images that are deployed, incremental development-stage images, or software images custom-made for this purpose based on the specifications of the images. These trap images 104 can be connected to the Internet or other data network so that malicious attacks 102 can be made against the trap images 104.

In some cases, the malicious attacks 102 made against the trap images 104 include ECU or embedded-systems specific attacks. That is, the malicious attacks 102 may be designed to target and exploit some ECU-specific or embedded-systems-specific device or flaw. In some cases, the malicious attacks 102 made against the trap image 104 include general-purpose attacks. For example, the trap images 104 may include a library useful to an ECU that is also commonly found in, for example, a desktop computer operating system. For example, a wireless network driver may be common to both ECUs and desktop computers, and an attack on a flaw in that driver may impact both an ECU and a desktop computer.

An attack analyzer 106 can be configured to monitor the malicious attacks 102 on the trap-images 104 and record information about the attacks. For example, the attack analyzer 106 may have a rule-set that identifies when a malicious attack has happened as opposed to a communication being a benign interaction from another system. The attack analyzer 106 may log information from any interaction or from malicious attacks. This log of information may include, for example, a timestamp, a source network address, a source geographical address, a communication protocol, a listing of commands received, etc. Further, this log can be augmented with data synthesized from analysis of the attack. For example, a malicious attack 102 that spans multiple connections can be given a single unique identifier, pattern-matching may be applied to the attack and any similar attacks may be flagged, etc.

From records of this information, the attack analyzer 106 can generate attack fingerprints 108. Attack fingerprints 108 include data that can be used to test future communications with an ECU in order to classify those interactions as malicious or not. For example, a malicious attack 102 may include the address of a known command-and-control (c&c) server for a bot-net. The attack analyzer 106 can identify such a malicious attack 102 as malicious and collect information about the attack. This attack can be compared with other similar attacks, and commonalities between the attacks can be found. In this example, the c&c address are common, and the fact that the attacks all occur on Saturday evening is identified. The attack analyzer 106 can generate an attack fingerprint 108 for the attack that specifies that c&c address and time window (i.e. Saturday evenings).

The attack analyzer 106 can send the attack fingerprint 108 to other systems for use. For example, a device manager 110 can receive the attack fingerprints 108 and use them to generate security updates 112 for a fleet of vehicles 114. The device manager 110 may be configured to provide updates to the ECUs of the vehicles 114, including security updates 112. This may include, for example, providing tangible computer-readable media (e.g., thumb drives) to personal responsible for maintenance of the automobiles, and/or may include wireless updates such as over-the-air data connections with the automobiles 114. The use of the term “fleet” should not be read to suggest that the automobiles 114 are necessarily all owned or operated by a single particular entity, though that is possible. The system 100 can be used to provide the security updates 112 to private owners of a single automobile 114.

Using the security updates 112, the ECUs of the automobiles 114 can be hardened against malicious attacks 116. For example, security software of the ECUs can be configured to deny network connections to any outside source when the connections have a profile that matches an attack fingerprint 108 in the security update 112. For example, a connection request containing the c&c address made on a Saturday evening can be matched to the attack fingerprint 108 and rejected. In this way, the security of the automobiles 114 is improved.

FIG. 2 is a block diagram of an example system 200 for collecting information of malicious attacks. Elements of the system 200 communicate through a data network 202, for example the Internet. As will be understood, the network 202 can include one or more networks, may be partitioned or connected in particular way, may have security and redundancy mechanisms, etc.

A trap image server system 204 includes one or more physical servers configured to host trap image 104 and to make the trap images 104 accessible over the network 202. In addition or in the alternative, the trap images server system 204 can be used to connect trap ECUs 206 with the network 202. As will be explained in more detail later, the trap images 104 and the trap ECUs 206 can operate as honeypots for the malicious attacks 106.

The trap image server system 204 can include heterogeneous hardware and software. For example, in order to attract the widest array of malicious attacks 106, different server types can be used. This can include different physical server hardware, different operating systems and virtual environments, hardware hosted on different data providers, and hardware hosted in different geographic locations. It may be, for example, that some of the trap image servers may be hosted in a managed-hosting solution in Europe, while some of the trap image servers may be physical servers in a private data center in Asia connected to the network 202 on a different provider network, while some trap image server may be virtual servers in a data center in North America connected with still a different data network.

Malicious attackers 208 can include hardware and software used by one or more attackers to perform the malicious attacks 102. As will be understood, the malicious attackers 208 can take nearly any arrangement of computing technology as attackers are constantly searching for new ways to exploits target systems. As such, the malicious attackers 208 can include server systems, desktop or laptop computers, mobile computing devices, emulated environments, etc.

The trap image server system 204 can store attack fingerprints 108 in a fingerprint datastore 210 via the network 202. The device manager 110 can access the attack fingerprints 108 from the fingerprint datastore 210 via the network 202. As shown here, the fingerprint datastore 210 is a separate device from the trap image server system 204 and the device manager 110. However, is some implementations, the fingerprint datastore 210 may be a component of the trap image server system 204 or of the device manager 110.

The fingerprint datastore 210 can include a database (e.g., a relational database or non-relational database) and can store data objects provided by other elements of the system 200. The fingerprint datastore 210 can respond to queries by identifying one or more data objects that match the query and return the stored data object to the querying system. For example, the device manager 110 may request the N newest attack fingerprints 108, or may request all attack fingerprints 108 stored since a particular time. In response, the fingerprint datastore 210 can identify one or more stored data objects of the attack fingerprints 108 and return those to the device manager 110. Other storage and retrieval schemes are possible. For example, each attack fingerprint 108 may be given a unique address, and elements of the system 200 can request attack fingerprints 108 by reference to that unique address.

Fleet ECUs 212 are ECUs in the automobiles 114 or that will be installed in an automobile. The automobile device manager 110 is in data communication with the fleet ECUs 212. In some examples, such as is shown here, the data communication is not via the network 202. That is, the device manager 110 communicates with the fleet ECUs by some data network that is not part of, for example, the internet. This may be used, for example, when the fleet ECUs 212 have not yet been put into production and are still in development or in the manufacturing stage, when the fleet ECUs 212 do not have an Internet connection, etc. While not shown here, communication between the automotive fleet data manager and some or all of the fleet ECUs 212 may be via the network 202 (e.g., the Internet). This may be used, for example, when the fleet ECUs are in use and when the fleet ECUs have an Internet connection.

While a particular type and arrangement of elements is shown here, it will be understood that other types and arrangements of elements are possible. For example, in some configurations the attack analyzer 106 and the trap image server system 204 are a single element. In another example, the trap ECUs 206 can connect directly to the network 202 instead of to the trap image server system 204.

FIG. 3 is a block diagram of example systems 300 made available over data networks. In the system 300, three kinds of fingerprints are being generated and stored in the fingerprint datastore 210. In some cases, these three kinds of fingerprints are generated in sequence, where one type of fingerprint is made for a period of time, then another fingerprint is generated for a period of time, etc. In some cases, different types of fingerprints are generated at the same time. Although a three types of fingerprints are shown in this example, it will be understood that different numbers of types of fingerprints can be generated in other examples.

Library fingerprints 300 are fingerprints generated based on trap images that include libraries that are (or are expected to be) included in an ECU to be hardened. For example, early in the development of an ECU, specifications for the ECU may be drawn up that describe software components that will be used by the ECU. Some of these components are custom or otherwise do not yet exists, while some of these components are libraries already do exist. For example, a wireless network driver, a memory-management library, or an off-the-shelf operating system may be specified for use by the ECUs. While it may not provide for all possible fingerprints for the as-of-yet undeveloped ECUs, library fingerprints 300 can be generated based on the libraries that are available at this stage in the ECU development.

The trap image server system 204 can host virtual machines 306 that include libraries 308. The libraries 308 are the libraries called for in the ECU specification, or possibly similar libraries. The virtual machine 306 is a controlled computer environment hosted by the trap image server system 204. The virtual machine 306 may include an emulated computer hardware, or may create an execution environment that abstracts away from the trap image server system 204 hardware. The virtual machine 306, being a honeypot, may be configured with security and monitoring features so that, when a malicious attack is performed on the virtual machine 306, that attack is trapped or “sandboxed” within the virtual machine 306. Operations of the attack such as system calls, network communication, and the like can be recorded by the virtual machine 306.

The malicious attack can include attacks on or using the libraries 308. For example, an attack on the library 308 may attempt to use a buffer-overrun exploit to initiate execution of arbitrary code within the virtual machine 306. When this attack is attempted (whether successful or unsuccessful) the virtual machine 306 can record actions taken. In some cases, elements of the virtual machine are inaccessible to the environment in which the libraries 308 execute, and one or more supervisors in those elements monitor the actions in the environment.

From this information, the attack analyzer 106 can generate library fingerprints 300 for storage in the fingerprint datastore 210. The fingerprint datastore 210 can store data of the library fingerprints 300 and make that data available, for example to the device manager 110. The device manager 110 can then use that data to harden the ECUs, for example by modifying the development path of the ECU images to eliminate security vulnerabilities used by the malicious attacks that generated the library fingerprints.

Later in the development lifetime of the ECUs, a ECU image (or candidate image) may be generated and made available. This image is the software that will be loaded into an ECU that is put into production. However, in some cases, this image is made available before the final ECU is made available. The trap image server system 204 can generate image fingerprints based on the ECU image, and those image fingerprints 302 can be used to harden the ECUs. In some cases, ECU images may be used even when finalized ECUs, including hardware, are available. For example, it may be the case that only a limited number of ECUs are available for fingerprint generation, or it may be the case that hosting an image is much more cost effective than using the complete ECU with hardware. As such, it may be desirable to use a mix of images and complete ECUs, or only images even if ECUs are available.

An ECU image VM 310 is hosted on the trap image server system 204 and contains libraries 312. The ECU image virtual machine (VM) 310 may be a different virtual machine from the virtual machine 306 in one or more ways. For example, in some cases the virtual machine 306 may be an emulation of a desktop computer while the ECU image VM 310 may be an emulated embedded device. In some cases, the virtual machine 306 and the ECU image VM 310 may be generally or completely the same in many or all ways. For example, the virtual machine 306 and the ECU image VM 310 may both be the same version of an embedded system emulator.

Libraries 312 are included in the ECU image VM 310 and can be updated from the libraries 308, or can be the same as libraries 308. For example, one of the libraries in the libraries 308 may have released a new version, and the libraries 312 may use that updated version if the final ECUs will be using that updated version. In another example, the development plans for the ECU may change and a different library than originally planned may be used for some purpose. In this case, the libraries 312 may include the new library and not the one that will not be used.

The image fingerprints 302 can be generated by the attack analyzer 106 and stored in the fingerprint datastore 210 based on malicious attacks on the ECU image VM 310. In some cases, the image fingerprints 302 may identified in the fingerprint datastore 210 in a way that allows for easy identification. For example, a field in each fingerprint may hold a value such as “Library,” “Image,” or “ECU.”

Once made available, ECU hardware hosting ECU software 314 can be used as a honeypot for the generation of ECU fingerprints 304 by the attack analyzer 106. Once the ECU hardware and software are finalized, or put in a candidate finalization, etc, the ECU can be connected to the network 202 to receive malicious attacks. The libraries 316 may be the same or different than the libraries 312 and/or 308, depending on the events of development of the ECU.

ECU fingerprints 304 can be generated by the attack analyzer 106 and stored in the fingerprint datastore 210 based on malicious attacks on the ECU hardware 206 and the ECU software 314. In some cases, ECU fingerprints 304 may be identified in the fingerprint datastore 210 in a way that allows for easy identification.

FIG. 4 is a flowchart of an example process 400 for hardening electronic control units. In the process 400, ECU libraries, ECU images, and ECUs are exposed to public networks to act as honeypots. Malicious attacks on these honeypots are examined, and the information gathered is used to develop and harden the ECUs. The description of the process 400 will be described with reference to time. In general, the times (time 1, time 2, and time 3) are used to organize similar tasks and to describe the chronology of the process 400. It will be understood that in some implementations, the times are separate and ordered, such that time 1 ends and time 2 begins after, and that time 2 ends and time 3 begins after. Some activities bridge a time. Other configurations of the process 400 are possible, including a process with elements in different time windows or without using time windows at all. The process 400 is being described as performed by the systems 100 and 200, however, other systems may be used to perform the process 400 or another different process.

The device manager 110 generates 402 an ECU specification. For example, developers can use the device manager 110 to generate specification for an ECU. The specifications can list the hardware and software goals for the development of the ECU. For example, they can specify that it should fit into a particular automobile's hardware harness, should communication on the automobile CAN bus, should receive sensor readings, should issue commands, etc. To meet those goals, the specification can indicate hardware and software that will be used. For example, hardware models, software libraries, an operating system, etc. can be specified.

The trap image server system 204 operates 404 a vm with the ECU libraries. For example, a virtual machine running some or all of the libraries called for in the ECU specification can be generated and hosted by the trap image server system 204. Malicious attacks on the virtual machine can be observed and logged.

The trap image server system 204 transmits 406 library records to the attack analyzer 106. For example, the trap image server system 204 can store the logs of the attack in the fingerprint datastore 210 and the attack analyzer 106 can access the logs from the fingerprint datastore 210.

The attack analyzer 106 generates 408 library fingerprints. For example, the attack analyzer 106 can examine logs from a group of similar attacks and identify data that is the same across the attacks. The library fingerprints may specify this data found to be the same. In some cases, the trigger to identify an attack can include a finding that some malicious behavior happens on the device. This can take the form of some privilege escalation, etc. (process gained privileges it shouldn't have, memory area that changed its type from data to executable, etc.)

The device manager 110 generates 410 an ECU image. For example, developers can develop software code using the libraries to meet the goals of the ECU as called for in the specification. In some cases, the developers will use information learned from the library fingerprints to harden the ECU image. For example, the developers may learn about a flaw in the libraries based on the library fingerprints and my update the libraries in order to remove that flaw, thus hardening the ECU image from that attack.

The trap image server system 204 operates 412 a vm with the ECU image. For example, the ECU image can be used in a virtual machine that emulates an ECU. Malicious attacks on the virtual machine can be observed and logged.

The trap image server system 204 transmits 414 image records to the attack analyzer 106. For example, the trap image server system 204 can store the logs of the attack in the fingerprint datastore 210 and the attack analyzer 106 can access the logs from the fingerprint datastore 210.

The attack analyzer 106 generates 416 library fingerprints. For example, the attack analyzer 106 can examine logs from a group of similar attacks and identify data that is the same across the attacks. The image fingerprints may specify this data found to be the same. When an image is being serviced, a hypervisor of the image can be used for these types of tasks. This may be beneficial as a hypervisor can be made more difficult than native code to detect by malicious actors.

The device manager 110 generates 418 an ECU. For example, developers can develop the final ECU that runs the ECU image on ECU hardware. In some cases, the developers will use information learned from the library fingerprints and/or the image fingerprints to harden the ECU. For example, the developers may learn about a flaw in the ECU image (e.g., possibly in the libraries or possibly in the operating system, etc) based on the library fingerprints and/or the image fingerprints and my update the libraries, the image, or the ECU hardware in order to remove that flaw, thus hardening the ECU from that attack.

The trap image server system 204 exposes 420 the ECU to a public network. For example, the trap image server system 204 can act as a network gateway, proxy, firewall, etc for ECUs. As such, the trap image server system 204 can monitor all network traffic to and from the ECUs. Malicious attacks on the ECUs can be observed and logged. Sensors at various levels including the CPU level, memory level, file system level and network level may be used to capture malicious attack information. On real ECUs, sensor software can be added to ECU software, and on images the sensors can be included, for example, in hypervisors.

The trap image server system 204 transmits 422 ECU records to the attack analyzer 106. For example, the trap image server system 204 can store the logs of the attack in the fingerprint datastore 210 and the attack analyzer 106 can access the logs from the fingerprint datastore 210.

The attack analyzer 106 generates 424 ECU fingerprints. For example, the attack analyzer 106 can examine logs from a group of similar attacks and identify data that is the same across the attacks. The image fingerprints may specify this data found to be the same.

The device manager 110 generates 426 security updates for the ECU. For example, developers can a patch for the ECU image, a hardware change for the ECU hardware, or a software update for an anti-malware service in the ECU. These changes may be made pre-production to future ECUs not yet manufactured, or may be applied to ECUs already manufactured and installed in automobiles. In this way, security flaws in the ECU may be minimized resulting in an ECU advantageously hardened from malicious attack.

FIGS. 5A-5C are flowcharts of example processes 500, 525, and 550 for hosting honeypots. The processes 500 describes a process for operating a VM with ECU libraries 404, and thus may be used by the trap image server 204 in the process 400. However, other processes for operating a VM with ECU libraries 404 are possible.

VMs with libraries is hosted 502. For example, hosting hardware may create virtual machines that include libraries, data objects, etc that are known to or expected to be include in an ECU. In some cases, an image is generated once, and that image is replicated across many different hosting devices in virtual machines on each hosting device. These virtual machine may emulate a physical device such as a physical electronic controller, a physical ECU, a physical server, or a physical desktop computer. In some cases, these virtual machines may not emulate a physical device and may instead provide a virtual environment sometimes called a sandbox that is abstracted away from any particular hardware implementation.

The vm with libraries is exposed 504 to a data network. For example, the hosting system can assign a network address to the vm and route any network traffic to that address to the vm. In addition, the hosting system can intentionally reduce or remove common security measures or take actions in order to encourage malicious attacks against the vm. For example, anti-malware applications can be disabled to downgraded to an old version known to have flaws. Data with provocative filenames can be placed into user-level directories, and network traffic with suspect websites can be initiated for the vm.

Malicious attacks on the VM are identified 506. For example, the hosting system can monitor network traffic and the state of the VM for events that match a rule-set of states indicative of a malicious attack. For example, file-read operations on sensitive data, execution of unsigned code or document macros, and automatic generation of new network messages may be specified by the rule-set as indicative of a malicious attack. When those rules are matched, the hosting system can identify the malicious attack occurring.

Library records are generated 508. For example, network traffic and state information of the vm may be recorded and indexed. This information may be stored in logs that easily parsable in order to generate intelligence about the kind of malicious attacks that are possible against the corresponding ECU and to understand how to harden the ECU against such attacks.

The processes 525 describes a process for operating a VM with an ECU image 412, and thus may be used by the trap image server 204 in the process 400. However, other processes for operating a VM with ECU image 412 are possible.

VMs with libraries is hosted 527. For example, hosting hardware may create virtual machines that include an image of an ECU's software or firmware. This image can include libraries, data objects, etc that are known to or expected to be include in an ECU. In some cases, an image is generated once, and that image is replicated across many different hosting devices in virtual machines on each hosting device. These virtual machine may emulate a physical device such as a physical electronic controller, a physical ECU, a physical server, or a physical desktop computer. In some cases, these virtual machines may not emulate a physical device and may instead provide a virtual environment sometimes called a sandbox that is abstracted away from any particular hardware implementation.

The vm with libraries is exposed 529 to a data network. For example, the hosting system can assign a network address to the vm and route any network traffic to that address to the vm. In addition, the hosting system can intentionally reduce or remove common security measures or take actions in order to encourage malicious attacks against the vm. For example, anti-malware applications can be disabled to downgraded to an old version known to have flaws. Data with provocative filenames can be placed into user-level directories, and network traffic with suspect websites can be initiated for the vm.

Malicious attacks on the VM are identified 531. For example, the hosting system can monitor network traffic and the state of the VM for events that match a rule-set of states indicative of a malicious attack. For example, file-read operations on sensitive data, execution of unsigned code or document macros, and automatic generation of new network messages may be specified by the rule-set as indicative of a malicious attack. When those rules are matched, the hosting system can identify the malicious attack occurring.

Image records are generated 533. For example, network traffic and state information of the vm may be recorded and indexed. This information may be stored in logs that easily parsable in order to generate intelligence about the kind of malicious attacks that are possible against the corresponding ECU and to understand how to harden the ECU against such attacks.

The processes 550 describes a process for exposing 420 an ECU to a data network, and thus may be used by the trap image server 204 in the process 400. However, other processes for operating a VM with ECU image 412 are possible.

The vm with libraries is exposed 529 to a data network. For example, the hosting system can connect with the ECUs and with a data network an allow network communication between the two to pass. The hosting system can assign a network address to the ECU and route any network traffic to that address to the ECU to reach the ECU. In addition, the hosting system can intentionally reduce or remove common security measures or take actions in order to encourage malicious attacks against the ECU. For example, anti-malware applications can be disabled to downgraded to an old version known to have flaws. Data with provocative filenames can be placed into user-level directories, and network traffic with suspect websites can be initiated for the vm.

Malicious attacks on the ECU are identified 531. For example, the hosting system can monitor network traffic and the state of the ECU for events that match a rule-set of states indicative of a malicious attack. For example, file-read operations on sensitive data, execution of unsigned code or document macros, and automatic generation of new network messages may be specified by the rule-set as indicative of a malicious attack. When those rules are matched, the hosting system can identify the malicious attack occurring.

ECU records are generated 533. For example, network traffic and state information of the ECU may be recorded and indexed. This information may be stored in logs that easily parsable in order to generate intelligence about the kind of malicious attacks that are possible against the corresponding ECU and to understand how to harden the ECU against such attacks.

FIG. 6 shows an example of a computing device 600 and an example of a mobile computing device that can be used to implement the techniques described here. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 manages bandwidth-intensive operations for the computing device 600, while the low-speed interface 612 manages lower bandwidth-intensive operations. Such allocation of functions is exemplary only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 664, the expansion memory 674, or memory on the processor 652. In some implementations, the computer program product can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

FIG. 8 is a schematic diagram that shows an example of a system 800 for sensor validation of database information. In the illustrated example, a server computer system 805 is in communication with a database 810. The database 810 hosts information about a road environment, such as (but not limited to) maps, speed limits for various road segments, turn restrictions for various locations (e.g., no turn on red, no U-turn), traffic controls for various locations (e.g., stoplights), lane restrictions for various road segments (e.g., no passing zone, carpool-only lanes), vehicle weight restrictions for various road segments (e.g., axle weight limits, bridge weight limits), vehicle height restrictions for various road segments or locations (e.g., low overpass), detours for/around various locations, vehicle type restrictions for a various road segments (e.g., no trucks, busses only), cargo type restrictions for various road segments (e.g., explosives, anhydrous ammonia, biohazards), closures of various locations (e.g., road closed, bridge out), names of a various locations (e.g., street signs, highway numbers, off-ramp numbers), locations of various landmarks (e.g., mile markers).

The server computer system 805 is in communication with various sources of driving assistance information, including a collection of government entities 815 (e.g., department of transportation, public geographic information services) and a collection of private entities 820 (e.g., private map providers, survey firms). The server computer 805 communicates with the government entities 815 and private entities 820 over a network 825 (e.g., the Internet) to populate the information in the database 810.

A collection of vehicles 850a-850c are in communication with the server 105. Each of the vehicles 850a-850c is equipped with sensors and processors that can sense the presence and location of various landmarks in the surrounding environment. Such sensors will be discussed further in the description of FIG. 9. As the vehicles 850a-850c moves through its environment (e.g., road), they detect the presence or absence of nearby road status information, such as road signs and other roadside landmarks.

The vehicle 850a detects the presence of a landmark 860a, and identifies it as a speed limit sign (example source of road status information) configured to inform drivers that the speed limit for that particular stretch of road is 50 mph. The vehicle 850a determines that a 50 mph speed limit at that particular location is information 870a that can be compared to information in the database 810. Information 880a from the database 810, however, indicates that the road has a speed limit of 55 mph. Obviously, there is a discrepancy between what the vehicle 850a has sensed and what the database 810 information says. As such, the system 800 needs to determine what information is correct. For example, the landmark 860a may have been recently replaced (e.g., the speed limit may have been reduced) and as such the information 880a may be out of date. However, in another example, the information 880a may be accurate but the sensed information 870a may be in error (e.g., incorrect parsing of the sign information, graffiti alteration of the sign, partial obfuscation of the sign by snow, fog, or vegetation, accidental identification of unofficial or non-sign information as a road sign). Processes for comparing and handling sensed information and database information are discussed further in the descriptions of FIGS. 10-12.

The vehicle 850b detects the presence of a landmark 860b, and identifies it as a stop sign (example road status information). The vehicle 850b determines that a requirement for vehicles to stop at that particular location is information 870b that can be compared to information in the database 810. Information 880b from the database 810, confirms that a stop sign is expected to be present at that particular location. Processes for comparing and handling sensed information and database information are discussed further in the descriptions of FIGS. 10-12.

The vehicle 850c receives information 880c that indicates that a landmark 860c (a stop sign in the illustrated example) is expected to be present at a particular location. However, at the particular location, the vehicle 850c fails to detect the presence of the landmark 860c. The vehicle 850c determines that the absence of the landmark 860c at that particular location is information 870c that can be compared to information in the database 810. Again, there is a discrepancy between what the vehicle 850c has sensed and what the database 810 information says. As such, the system 800 needs to determine what information is correct. For example, the landmark 860c may have been recently removed and as such the information 880c may be out of date. However, in another example, the information 880c may be accurate but the sensed information 870c may be in error (e.g., the stop sign may have been knocked down during a recent traffic accident and will be replaced soon, the view of the sign may have been temporarily blocked by another car or other object). Processes for comparing and handling sensed information and database information are discussed further in the descriptions of FIGS. 10-12.

FIG. 9 is a block diagram that shows an example of a system 900 for sensor validation of database information. The system 900 includes a vehicle 901. In some embodiments, the vehicle 901 can be the vehicle 850a, 850b, and/or 850c of FIG. 8. The vehicle includes a controller 910 that is configured as a sensor data processing system. In some embodiments, the controller 910 can be all or part of an autonomous or semi-autonomous vehicle navigation system (e.g., a controller for a self-driving car or truck).

The controller 910 includes a processor 930. The processor 930 is configured to perform operations of computer instructions that are stored in a data storage system 932 and/or an electronic memory 934. The processor is also configured to communicate with an input/output interface 936. The input/output interface 936 provides communication interfaces between the processor 930 and external systems, including a sensor system 950 (e.g., a camera), a rangefinder system 952 (e.g., RADAR, LIDAR, SONAR), and a position sensor system 954 (e.g., global and/or local positioning system, GPS, GLONASS).

In some embodiments, the systems 932-934 can be subsystems of a vehicle navigation or automated piloting system of a vehicle. For example, the image sensor system 950 can be used for lane guidance, and can also be used for observing and gathering image data from the example landmarks 860a-860c of FIG. 8. In another example, the position sensor system 954 and/or the rangefinder system 952 can be used for positioning the vehicle 901 within a road environment, and can be used to estimate the position of the landmarks 860a-860c near the vehicle 901.

The input/output interface 936 also provides communication interfaces between the processor 930 and a wireless transceiver system 956. The wireless transceiver system 956 is configured to transmit and receive wireless communication (e.g., cellular data, satellite data, wireless Ethernet data). In the illustrated example, the wireless transceiver system 956 is in communication with a cellular tower 960 (e.g., to provide a communication bridge to the example network 825 of FIG. 8), the example server computer system 805, and the example database 810.

FIG. 10 is flow chart that shows an example of a process 1000 for sensor validation of database information. In some implementations, the process 1000 can be performed by all or parts of the example system 800 of FIG. 8 and/or the example system 900 of FIG. 9.

At 1010, road information is received. For example, the server computer system 805 and the database 810 can receive driving assistance data, road construction data, detour data, and other information about roads and road environments from the government entities 815 and the private entities 820. In another example, the controller 910 can receive road information from the server computer system 805 and the database 810. This information can include things such as the speed limits for various stretches of road, the locations of stops, the identities of roads and off-ramps, restrictions for various stretches of road (e.g., one-ways, no-passing zones, weight limits, height limits, local traffic only).

At 1020, image data of a road environment is captured. For example, the controller 910 and the image sensor system 950 can capture an image that includes one or more of the example landmarks 860a-860c.

At 1030, a determination is made. The image data is processed (e.g., machine vision, image processing, artificial intelligence) to determine if driving assistance information, such as a road sign or other landmark, is included in the image. If no driving assistance information (e.g., road sign or other such landmark) is in the captured image, then the process 1000 continues at 1010. If a road sign or other such landmark is found in the image, then the process continues at 1040.

At 1040, the information provided by the captured image of the road environment is interpreted to determine road status information. For example, machine vision techniques can be used to determine that an inverted yellow triangle is a “yield” sign, or that a red octagon is a “stop” sign. In another example, optical character recognition can be used to determine the meaning of a sign, such as “speed limit 65” or “construction ahead—merge left”. In other examples, similar techniques can be combined to permit the controller 900 to differentiate properly among, for example, a mile marker “65”, a sign for exit “65”, a sign for highway “65”, and a sign showing a speed limit of “65”.

At 1050 another determination is made. The interpreted information is compared to the received road information. If the interpreted information is substantially in agreement with the received road information, then the process continues at 1060. For example, in the example of FIG. 8, the information in the database 810 can indicate that traffic is required to stop at a particular location, and the vehicle 150b can determine that a stop sign (e.g., the landmark 160b) is located at or near the expected location. Returning to FIG. 10, at 1060 a confirmation of the sign information is transmitted. For example, the controller 910 can notify the server computer system 805 that the information in the database 810 regarding the location of the stop has been verified.

If at 1050 the interpreted information is substantially in disagreement with the received road information, then the process continues at 1070. For example, in the example of FIG. 8, the information in the database 810 can indicate that a particular stretch of road is believed to have a speed limit of 55 mph, but the vehicle 850a can determine that the landmark 860a says that the road has a speed limit of 50 mph. Returning to FIG. 10, at 1070 information about the sign information is transmitted. For example, the controller 910 can notify the server computer system 805 that the information in the database 810 regarding the speed limit may be in disagreement. In some implementations, sensor data from the controller can be sent to the server 805. For example, raw image data from the image sensor system 950 that was used to make the determination can be sent to the server computer system 805 for further processing and/or manual review. In some implementations, subsets of sensor data may be transmitted. For example, instead of sending an entire raw image to the server 805, the controller 910 can send just the pixels that make up what has been identified as the landmark 860a to reduce transmission bandwidth and/or to increase communication speed. The controller 910 may also perform data reducing and/or compression processes upon the sensor data before transmission in order to reduce transmission bandwidth and/or to increase communication speed.

FIG. 11 is flow chart that shows another example of a process 1100 for sensor validation of database information. In some implementations, the process 1100 can be performed by all or parts of the example system 800 of FIG. 8 and/or the example system 900 of FIG. 9.

At 1110, driving assistance information (e.g., sign or other landmark information) is received. For example, the example controller 910 of FIG. 9 can send confirmation message to the server computer system 805 to indicate that the information about a landmark has been confirmed, of the controller 910 can send a message to the server computer system 805 to indicate that the information about a landmark may conflict with information that has been sensed by the controller 910 for the landmark.

Various landmarks that are identified in the database include a confidence value or metric that indicates a variable level of certainty that the information about a particular sign, road, restriction, limit, location, or other attribute or object is accurate. For example, the example information 880a may have a confidence level of 70%, while the information 880b may have a confidence level of 98%.

At 1115, a determination is made. If the information received at 1110 is a confirmation of known driving assistance information (e.g., confirmation about the sign or landmark), then at 1120 a confidence level in that information is increased. For example, the server computer system 805 may use the example information 870b to increase the confidence level associated with the example landmark 860b from 98% to 99%. If the determination at 1115 is that the information received at 1110 indicates a discrepancy, and/or includes image, location, and/or other sensor data, then the process continues at 1130.

At 1130, image data and other details from the driving assistance information (e.g., image data of the sign or other landmark) is processed. For example, the server computer system 805 can perform image processing algorithms, machine vision algorithms, pattern matching algorithms, optical character recognition algorithms, machine learning algorithms, and combinations of these and other appropriate processes for parsing information from image and other sensor data.

At 1132, details are extracted from the driving assistance information. For example, the example information 870a may be parsed to extract information that indicates that the landmark 860a is a speed limit sign configured to inform a reader that a particular section of road as a speed limit of 50 mph.

At 1134, a driving assistance database is queried. For example the server computer system 805 can query the database 810 for information about landmarks and/or road attributes at or near the location from which the received information was sensed.

At 1140 a determination is made. If the database query indicates that no data or record exists for the driving assistance information (e.g., sign or landmark), then at 1150 new information is added to the database to describe the driving assistance information. For example, a highway department may put up a temporary “bump” sign to warn drivers of a ridge or pothole in a road, and the controller 910 may sense the presence of the sign, and the server computer system 805 can add that sign to the database 810. In some implementations, a newly added landmark may be given a low confidence level, such as 1%, 5%, or 10%, to prevent the information from being used to alter vehicular behavior until the landmark can be confirmed. For example, each time the same or another vehicle senses the “bump” sign at the same location, the confidence level associated with that landmark may be increase (e.g., by 1%, 2%) at 420.

If at 1140 the database query indicates that data or a record exists for the driving assistance information, then at 1160 another determination is made. If information from the database and the information extracted from the sensor data are substantially the same, then the confidence level associated with the existing database information is increased at 1120.

If, at 1140, the information from the database and the information extracted from the sensor data are not substantially the same, then the confidence level associated with the existing database information is decreased at 1170. For example, the 70% confidence level associated with the accuracy of the speed limit of the road near the landmark 860a can be reduced to 69%, 68%, 60%, or any other appropriate decreased value.

FIG. 12 is flow chart that shows another example of a process 1200 for visual sensor validation of database information. In some implementations, the process 1200 can be performed by all or parts of the example system 800 of FIG. 8 and/or the example system 900 of FIG. 9.

At 1202, a database update type is determined. In the illustrated example, three update types are differentiated from each other. If the update type is configured to add a new driving assistance information (e.g., landmark or sign) to the database, then the process continues at 1210. If the update type is configured to increase confidence in an existing driving assistance information (e.g., landmark or sign) already in the database, then the process continues at 1220. If the update type is configured to decrease confidence in an existing driving assistance information (e.g., landmark or sign) already in the database, then the process continues at 1230.

At 1210, the location of the new driving assistance information (e.g., sign or landmark) is added to the database. For example, a new data record can be added to the database 810, and location data can be stored as one or more fields of the record.

At 1212, the information provided by the new driving assistance information (e.g., sign or landmark) is added to the database. For example, speed limit, turn restriction, traffic control, lane restriction, vehicle weight restriction, vehicle height restriction, detour, vehicle type restriction, cargo type restriction, closure, name, location, and/or combinations of these and other appropriate information can be can be stored as one or more fields of the record for the new landmark.

At 1214, and initial confidence level is set for the new driving assistance information (e.g., sign or landmark). For example, a “confidence” field in the record for the new landmark can be added with a relatively low initial value (e.g., 1%, 10%) to indicate that the sign or landmark has been seen, but perhaps not often or long enough to be sure that it is real (e.g., and not a sensor glitch or a misidentification of something other than a real or permanent traffic sign, such as a stopped school bus with its “stop” arm extended or a pedestrian wearing a “zombie x-ing” parody t-shirt). At 1240, the confidence level is stored in the database in association with the identified landmark.

If at 1202 the update type is configured to increase confidence in an existing driving assistance information (e.g., landmark or sign) already in the database, then the process continues at 1220. At 1220, the existing confidence value associated with the driving assistance information (e.g., sign or landmark) is determined. For example, the database 810 can be queried to determine the current confidence value associated with the landmark 860b (e.g., 90%).

At 1222, the confidence level is increased. For example, each confirmation of a landmark's location and information may increase the confidence level for the information associated with that landmark by 1% (e.g., 90%+1%=91%). At 1240, the confidence level is stored in the database association with the identified landmark.

If at 1202 the update type is configured to decrease confidence in an existing driving assistance information (e.g., landmark or sign) already in the database, then the process continues at 1230. At 1230, the existing confidence value associated with the driving assistance information (e.g., sign or landmark) is determined. For example, the database 810 can be queried to determine the current confidence value associated with the landmark 860a (e.g., 60%).

At 1232, the confidence level is decreased. For example, each confirmation of a landmark's location and information may decrease the confidence level for the information associated with that landmark by 1% (e.g., 60%-1%=59%). At 1240, the confidence level is stored in the database association with the identified landmark.

At 1250 a determination is made. The confidence level associated with the identified landmark is compared to a predetermined threshold confidence level to determine whether or not a landmark should be treated as accurate or not.

If at 1250, the confidence level satisfies the predetermined threshold, then at 1260 the driving assistance information is provided as part of the road information. For example, if the confidence associated with the information 880b is high enough (e.g., above the threshold) then the landmark 860b (e.g., stop sign) may be treated as being “real” and therefore necessary to obey. As such, information (e.g., the information 880b) about the stop can be provided a driver assistance or automated piloting system of the vehicle 850b so the vehicle 860b can make a stop at the identified location. Since the confidence level is high, the information about the landmark is kept in the database at 1270.

If at 1250, the confidence level does not satisfy the predetermined threshold, then at 1280 the driving assistance (e.g., sign or landmark) information is not provided as part of the road information. For example, if the confidence associated with the information 880a is low enough (e.g., below the threshold) then the landmark (e.g., the misidentified “zombie x-ing” t-shirt) may not be treated as being “real” and therefore unnecessary to obey. As such, the driver assistance or automated piloting system of the vehicle 901 will not brake or slow down at the identified location (e.g., for zombies).

At 1290, another determination is made. If the confidence level of a particular driving assistance (e.g., sign or other landmark) satisfies a predetermined removal threshold, then the information about the landmark is kept in the database at 1270. For example, as long as the confidence level associated with the landmark 860c (e.g., the missing stop sign) remains high enough (e.g., above 1%), the stop will remain in the database and the information 880c will continue to be provided to the vehicle 850c to allow driver assistance and/or autonomous driving systems to continue to obey the stop even though the sign may be (temporarily) missing.

However, if the confidence level of the particular driving assistance information (e.g., sign or other landmark) fails to satisfy the predetermined removal threshold, then the information about the landmark is removed from the database at 1290. For example, once confidence in the information 880a (e.g., 55 mph) drops to 0% or below some other appropriate limit, then the 55 mph information may be purged from the database 810 and no longer provided to the example vehicles 860a-860c and 901.

Continuing in the context of the example landmark 860a, confidence in the “50 mph” limit may increase as more vehicles sense the landmark 860a and confirm its presence to the server computer system 805, and after an appropriate number of confirmations the landmark may become associated with a high enough level of confidence that the “50 mph” information may be provided to the vehicles 860a-860c and 900. As such, the behavior of driver assistance, partial, or full autonomous navigation system can be updated to alter the behavior of the vehicles 860a-860c and 900. For example, by purging the “55 mph” information 880a and replacing it with “50 mph” information, an automated vehicle piloting system can adjust the maximum speed of the vehicle to meet the legal speed limit for a particular stretch of road. Similarly, the systems 800 and 900, and the processes 1200-1200 can increase the operational safety of automated navigation systems by using sensed information to validate road information and alter the behavior of automated vehicles. For example, the systems and processes described above can add a new stop sign to the database 810 to permit other vehicles to more reliably obey the stop (e.g., and not cause a possible collision by being unware of it) even if the stop sign is temporarily obscured or missing (e.g., because the stop information can continue to be provided to vehicles even if there is no sign to sense directly).

FIG. 13 is a conceptual diagram of an example system 1300 for providing low overhead network security on example ECUs 1304a-n that are part of an example vehicle 1302. The example system 1300, the vehicle 1302, and the ECUs 1304a-n are illustrative examples of a specific IoT context within which improved cryptographic engines and techniques can be provided. The system 1300 can be implemented on a variety of other IoT devices and systems, including being implemented on other types of controllers (different from the ECUs 1304a-n), other types of networks (different from the CAN bus 1306), and in other types of IoT devices/systems (different from the system 1300 and vehicle 1302). For example, the system 1300 can be implemented on home automation controllers that are connected to each other within a smart home environment. The system 1300 can be applied to other IoT contexts and environments, as well.

In this example, the ECUs 1304a-n are depicted as being communicatively connected to each other via a CAN bus 1306, which is a communication network within the vehicle 1302. The CAN bus 1306 is one example type of network over which improved cryptographic engines and techniques can be implemented—application to other types of networks are also possible. Messages between the ECUs 1304a-n are broadcast over the CAN bus 1302 using message identifiers, with each ECU 1304a-n being configured to transmit and/or listen for messages that are transmitted over the CAN bus 1306 with a particular message identifier. If the messages are unencoded, all of the ECUs 1304a-n are able to read the contents of the messages. Furthermore, the only information that is used to identify the type of a message is included in the message headers, which can be spoofed. Thus, without cryptographic engine security, the messages over the CAN bus 1302 are susceptible to eavesdropping and spoofing.

Each of the ECUs 1304a-n can be loaded with a custom cryptographic engine 1312 (only depicted for ECU A 1304a, but also present in the other ECUs 1304b-n) that can be used to implement low overhead network security for the ECUs 1304a-n and the CAN bus 1306. In particular, the cryptographic engine 1312 includes cryptography techniques 114 that are programmed to efficiently convert cleartext messages that would otherwise be visible to all other ECUs on the CAN bus 1306 into cipher text in a way that can permit efficient decoding and authentication of message. The cryptography techniques 1314 can also provide in-place cryptography that does not add any overhead to message traffic that is transmitted over the CAN bus 1306—meaning that no additional data is added to network traffic as part of the cryptography and authentication scheme. This permits the cryptographic engine 1312 to have no performance impact on the CAN bus 1306, including avoiding unnecessarily consuming extra bandwidth on the CAN bus 1306. For example, conventional techniques for authenticating communication over a CAN bus have added authentication codes to messages, which consume extra network bandwidth. In contrast, cryptographically protected messages can be sent over the CAN bus 1306 and authenticated without such additional codes or bits being added to the messages, which can permit for message authentication to be accomplished without affecting the bandwidth of the CAN bus 1306. Additionally, by not adding any extra bits or fields/codes to the messages, transmission over the CAN bus 1306 can ensure continued backward compatibility with other systems and devices using the messaging protocol, including legacy lower-layer mechanisms. For example, lower-layer legacy mechanisms that provide portions of the CAN bus 1306 (e.g., components configured to send, receive, and retransmit message) can be configured to operate with messages of a certain length. By avoiding changing the message length, while at the same point still providing message authentication and cryptographic protections, backward compatibility with these components can be maintained, which permits this technology to be more readily and easily deployed across a broader range of networks (e.g., able to deploy without upgrading/modifying underlying system). In another example, network latency can be unaffected. For the vehicle 1302 and the CAN bus 1306 to be able to meet various operating specifications (e.g., industry specification, manufacturer specifications, regulatory requirements) for safe operation, the latency for network traffic may be required to be below a certain threshold. By providing in-place cryptography and authentication that does not add to the traffic on the CAN bus 1306, the cryptographic engine 1312 can enhance the security of the vehicle 1302 and its ECUs 1304a-n without any impact on the performance of the CAN bus 1306.

The cryptographic engine 1312 can include shared secrets 1316 that can be used by the cryptography techniques 1314 to encode, decode, and authenticate message traffic over the CAN bus 1306. For example, each of the ECUs 1304a-n can be programmed to establish symmetric cryptography keys for each of the ECU pairs and/or for each of the message identifiers. The symmetric keys and/or information that can be used to recreate the symmetric keys (e.g., public key of other controller) can be stored locally by the cryptographic engine 1312. For example, symmetric cryptography keys can be used to encode communication between senders and recipients so that only the sender and recipient, which are the only two ECUs with access to the symmetric cryptography key, are able to decode and read the information being transmitted. Additionally, these symmetric cryptography keys also permit for the sender and recipients to validate the identity of the purported sender of a message as identified via the message header. For example, ECU A 1304a and ECU B 1304b establish a symmetric key for that ECU-pair (ECU A and ECU B) that is then only known to those ECUs. The other ECUs are not privy to this key, so they are not able to decode messages between ECU A and B, or to spoof the identity of either of those ECUs to infiltrate communication between that ECU-pair.

The symmetric keys can be established between the ECUs 1304a-n in any of a variety of ways, such as through public key cryptography, like Diffie-Helman or other techniques for two parties to create a shared secret through publicly distributed information, and/or through loading the symmetric keys onto the ECUs 1304a-n (e.g., OEM generating secret keys that are loaded onto the ECUs 1304a-n).

The cryptographic engine 1312 includes components that are used, in combination with and as part of message cryptography, to authenticate encoded message traffic as being from an authentic/legitimate sender. For example, the authentication scheme can use cryptographic modules, such as block ciphers. Block ciphers can be used for authentication. Specifically, the authentication scheme can apply a block cipher as part of the process of encoding and authenticating a cleartext (also referred to as “plaintext”) message, resulting in a ciphertext message that is subsequently transmitted over the CAN bus 1306. The authentication scheme can also apply a dual process of decoding and validating a ciphertext message by the recipient of the message to transform it back into a validated cleartext message or into an error indicator if the validation fails. In each process—the encoding/authenticating and the decoding/validating-a block cipher can be applied multiple times (e.g., block cipher applied twice, block cipher applied three times, etc.). For example, in an instance where the block cipher is applied twice, a first application of a block cipher can be used create a pseudo-random variant of the current message counter (which can be XORed to the plaintext before entry to the block cipher) and the second application of a block cipher can be applied to output of the first application.

As part of the authentication scheme, messages are transmitted with zero network overhead—meaning that messages do not include any additional information that may otherwise be used by the recipient to authenticate or verify that the message payload has been decoded correctly or that it is from an authentic/valid sender (i.e., not from a corrupted ECU that is spoofing another ECU and injecting malicious traffic onto the CAN bus 1306). To do this, the cryptographic engine 1312 includes message models 1318 that can model the messaging behavior between ECUs 1304a-n on the CAN bus 1306. The message models 1318 can be a table mapping from each message type to a specific message model that identifies the redundancy in each message type, which is used to authenticate and validate the message types. Redundancy refers to the fact that a specific type of message can only be a subset of all possible strings (of same length). For example, a word in the English language has lots of redundancy compared to the set of all possible strings of same length—i.e., most strings of particular length are not valid words in English. A particular type of redundancy for a message type is when specific bits in the message have known values. Message models for each type of message can include a variety of details that can be used to authenticate messages of that type transmitted over the CAN bus 1306 without additional data being added to messages, such as permissible ranges for message values (e.g., message values range from first integer to second integer value), message types (e.g., string, integer, float, enumerated data type, Boolean value), message size (e.g., 1 byte, 2 bytes, 4 bytes, 8 bytes), message value sequences (e.g., progression of message values), message frequency (e.g., frequency with which particular messages are transmitted over CAN bus 1306), contingent message relationships (e.g., relationship in values across different message identifiers), and/or other features for modeling the authenticity of message values. There can be different message models 1318 for each of the message identifiers that are transmitted over the CAN bus 1306, and in some instances there can be separate models for each ECU 1304a-n for each message identifier that the ECU 1304a-n may listen for or transmit over the CAN bus 1306. The message models 1318 that are loaded onto each ECU 1304a-n can be limited to only those models (or portions thereof) that are relevant to those ECUs 1304a-n so as to minimize the resources that are used/dedicated on the ECUs 1304a-n to message authentication.

The message models 1318 can be determined and generated in advance of being installed on the ECUs 1304a-n in actual use. For instance, the message models 1318 can be determined in a safe and secure environment, such as in a testing environment that puts the vehicle 1302 through its full range of operation and conditions. Message models 1318 can be determined using any of a variety of appropriate modeling techniques, such as using static analysis, dynamic analysis, machine learning algorithms (e.g., neural networks, regression analysis, clustering techniques), and/or other techniques for generating the message models 1318.

In some instances, the cryptographic engine 1312 can optionally include a state information 1320 that can be used and analyzed with the message models 1318 to determine whether messages that are being received are authentic. For example, the cryptographic engine 1312 can use the state information 1320 as part of the authentication scheme, such as counters which can provide a state of messages transmitted for a particular message type and/or windows of recent messages. For example, each ECU 1304a-n can include a communication table 1322-126 with a listing of each message ID on the CAN bus 1306 that the specific ECU is sending or receiving messages (“SIR”—“S” represents sending and “R” represents receiving), keys that are used for each message ID, counters and/or other state information for each message ID, and redundancy information for each message ID (e.g., message models 1318 for each message ID). The cryptographic engine 1312 may optionally use other state information for message transmissions, which can be derived from a state information 1320 stored, at least temporarily during runtime, and can be used to determine whether current messages are being received over the CAN bus 1306 are authentic using a validation function, such as described below with regard to FIGS. 14, 5, and 6.

The vehicle 1302 can be communicatively connected to one or more remote computer systems 1310 (e.g., management computer system), which can communicate remotely with the ECUs 1304a-n via one or more gateways 1308 for a variety of purposes. For example, the remote computer system 1310 can monitor the status of the ECUs 1304a-n and, when a security threat is detected by one or more of the ECUs 1304a-n (e.g., inauthentic message detected that indicates potential security threat), can aggregate ECU status information and vehicle security information for presentation in one or more dashboards (e.g., manufacturer dashboard, OEM dashboard). The ECUs 1304a-n can generate alerts when potential security threats are detected, along with threat traces (e.g., message, associated message information, vehicle information at time of threat) that are transmitted to the remote computer system 1310, which can analyze the alerts, retransmit the alerts (e.g., alert manufacturer, alert driver via third party communication channel), and/or initiate threat mitigation operations.

FIG. 14 is a block diagram of example data 1400 that is encoded and decoded for communication over a CAN bus. The data 1400 shows information that may be used, for example, in communication between two ECUs 1304. The ECUs 1304 may be configured to transmit cleartext messages 1401 to each other, and the encoding and decoding applied as shown here may be used to protect the communication (i.e., obfuscate the cleartext) from third party spoofing, or from other security concerns. The example depicted in FIG. 14 (and FIG. 15) can be implemented in any of a variety of IoT contexts, such as in the system 1300 described above with regard to FIG. 13 and/or other IoT contexts (e.g., smart homes, security systems, automation systems, drone systems).

A cleartext message 1401 can include messages made up of, for example, one to eight bytes of data, each byte having eight bits of data. In this example, the cleartext message is made of one byte of data, but other message lengths are also possible. In other examples, a different number of bytes of data may be used, such as two to eight bytes of data, one to twelve bytes of data, etc.

The cleartext message 1401 may include or consist of sensor readings, remote procedure calls, instructions to actuate a controllable device, or other types of data that two IOT devices, for example controllers transmit to each other. For example, a cleartext message 1401 can include an engine temperature reading that is gathered by one ECU and transmitted to another ECU or broadcast to all ECUs in a single automobile. In another example, a cleartext message 1401 can include CAN commands, such as instructions to increase rotation, apply brakes, and/or change gears in the car that contains the ECUs. In a further example, a cleartext message 1401 can include instructions being transmitted among home automation controllers within a smart home environment, like instructions for a controller (e.g., garage door controller, smart lock controller) to unlock or open a door. Furthermore, although FIG. 14 is described with regard to ECUs, it can be applied to other types of controllers and other network environments.

The cleartext message 1401 can include non-redundant data 1402 and redundant data 1404. As explained above, redundant data 1404 refers to the patterns of data for each specific type of message, which include only be a subset of all possible strings (of same length). A particular type of redundancy for a message type is when specific bits in the message have patterns that lend themselves to being known values. The redundant data 1404, which are the predictable or expected portions of the cleartext message 1401, can be some or all of the cleartext message 1401. The non-redundant data 1402 can be other portions of the message 1401 that do include predictable or expected values based on the message identifier (or type) for the message 1401. For example, the redundant data 1404 may be portions of the message 1401 (based on its message type) with values that do not fluctuate or change, or that fluctuate or change in predictable or expected ways. In contrast, the non-redundant data 1402 may be portions of the message 1401 (based on its message type) with values that are not predictable or expected. For instance, in the depicted example in FIG. 14, the non-redundant data 1402 is two bits that, for the message type of the message 1401, do not have a well confined subset of values, such as values representing frequently changing and highly variable states in a vehicle, like speed, revolutions per minute (RPM) of an engine, and/or other values. In contrast, the redundant data 1404 in the depicted example is six bits that, for the message type of the message 1401, have a well confined subset of values that are predictable or expected, such as values representing predictable or invariable states in the vehicle. In some instances, the redundant data 1404 can be filler data that is not part of the message payload or content for the cleartext message 1401. Although depicted as having a split of two bits for the non-redundant data 1402 and six bits for the redundant data 1404, other combinations of the bits, bytes, or other portions of the cleartext message 1401 that are redundant data 1404 and the non-redundant data 1402 are also possible, and can depend on the message type for the cleartext message 1401. For example, with some message types, all of the bits of the cleartext message 1401 can be redundant data 1404. Additionally, with some message types, the redundant data 1404 can be non-continguous bits within the cleartext message 1401. As explained above, the cleartext message 1401 can have any of a number of standard lengths (e.g., 1 byte, 2 bytes, 4 bytes, 8 bytes), and the redundant data 1404 (bits, bytes) of the message 1401 can be determined based on the type for the message (e.g., the message identifier for the message 1401).

The message redundant data 1404 can include values that, based on the message id for the message 1401, are predictable/expected, which can be used by the recipient to authenticate the message 1401 without requiring the addition of any authentication bits (e.g., CRC code, hash values) to or other modifications of message 1401. The predictability of the redundant data 1404 can be based on the message id alone, and/or it can be additionally based on a sequence of messages for the message id. For example, the current message 1401 is part of a series of messages that are transmitted over the network for the message id, which in this example includes a previous message 1413 (with non-redundant data 1414 and redundant data 1416) and a next message 1417 (with non-redundant data 1418 and redundant data 1420). The value of the redundant data 1404 for the current message 1401 can be predicted by the recipient based on, for example, the identifier for the message 1401 alone and/or a based on a combination of the message identifier and of values contained in the previous message 1413 (or other previous messages in the sequence of messages). The predicted or expected value for the redundant data 1404 in the current message 1401 can be evaluated against the actual value of the redundant data 1404 to validate the redundancy in the message (1224), which can be performed by the sender of the message 1401 (to ensure that the message 1401 includes redundant data 1404 that can be validated by the recipient) before sending the message 1401 and can be performed by the recipient of the message 1401 to authenticate the message 1401. For example, redundancy patterns 1420, which can be part of a model for the message id, can be pregenerated through dynamic and static analysis of the ECU and network behavior, and can define expected values (e.g., static values, dynamically changing values, permissible ranges of values) in the redundant data 1404 for message of a corresponding type. Such a redundancy patterns 1420 can be loaded onto the ECU and used to identify an expected value and/or a range of expected values for the redundant data 1404. In-place authentication is designed assuming messages (e.g., message 1401) has significant amount of redundancy, as represented by the redundant data 1404. The redundancy may be different for different message types; for example, one message type may have a simple fixed pattern to all messages, e.g., all begin with a specific prefix (e.g., the first few bits are all zeros). Another message type may have more dynamic redundancy, e.g., message contain a value of some counter or physical value, and hence, only minor changes are possible in this value from one message to the next. The redundancy for a specific message type can be represented by its model, which includes redundancy patterns 1420. In a system deploying the scheme, the controller can maintain a table identifying the model of each message type. This table would be generated as part of the system design, e.g., by vehicle manufacturer. The generation may involve manual and/or automated processes, e.g., using machine learning.

As depicted in FIG. 14, both the sender and recipient (as well as other controllers transmitting and/or listening to the type of the message 1401) can maintain a counter 1406 for the type of message 1401. The counter 1406 can simply be incremented (or otherwise changed in predetermined ways) as messages of the type for the message 1401 are transmitted over the network (e.g., CAN bus).

The counter 1406 can be transformed into a pseudo-random counter 1408 through the use of a first key 1407 that is combined with the counter using a pseudorandom function (PRF) 1409. The first key 1407 can be a shared secret between the sender and recipient controllers, such as a symmetric key value (or other type of key) that is securely stored/reproducible by both the sender and recipient. Any of a variety of PRFs can be used as the PRF 1409, such as a block cipher, a look-up table, and/or other type of PRF.

Once the redundancy of the cleartext message 1401 (which includes the non-redundant data 1402 and the redundant data 1404) has been validated (1424), the cleartext message 1401 and the pseudo-random counter 1408 can be combined (1411) to create a randomized message 1410. For example, the cleartext message 1401 and the pseudo-random counter 1408 can be combined using an XOR operation 1411.

The randomized message 1410 can be subject to a block cipher encoding process 1413, which can use a key 1430 to encode the randomized message 1410, to create a ciphertext 1412. Various block cipher encoding schemes are possible, with some discussed in more detail later. The key 1430 can be a shared secret between the sender and recipient controllers, similar to the key 1407. Other encoding processes different from block ciphers may additionally and/or alternatively be used. The ciphertext 1412 may then, once created, be passed from one ECU to another ECU over a CAN bus or broadcast to all available ECUs on a CAN bus. By passing the ciphertext 1412 instead of, for example, the cleartext message 1401, the ECUs can communicate in a way that is hardened from eavesdropping, spoofing, etc.

As shown, the receiving ECU can perform the same operations of the sender, but in reverse order to turn to the ciphertext into the cleartext message 1401, including performing a block cipher decoding 1415 of the ciphertext 1412 to generate the randomized message 1410, generating the pseudo-random counter 1408 and combining it via an XOR operation 1411 with the randomized message 1410 to obtain the cleartext message 1401. The receiving ECU also validates (1424) the predictable data 1404 before accepting the cleartext message 1401 through the use of redundancy patterns 1420 for the message type to determine expected values for the redundant data 1404. If the expected value matches the actual redundant data 1404 in the decoded message 1401, then the message 1401 can be validated as originating from an authentic source (as opposed to another source spoofing the identity of the sender) and permit the controller to use the message 1401 (1426). In contrast, if the expected value does not match the actual redundant data 1404 in the decoded message, then the message can be dropped by the controller and/or an alert can be generated (1428). Such an alert can indicate any of a variety of problems that may exist, such as a third party attempting to spoof the identity of the sender, and/or the sender and the recipient falling out of sync with regard to their shared secrets (key 1407, key 1430) and/or their shared counter value 1406 with regard to the message type.

For the block ciphers described above with regard to FIG. 14, and throughout this document, an existing block cipher can be used when available for particular block lengths. For example, the SPECK 32/64 block cipher can be used for blocks (e.g., messages) that are 4 bytes in length, the SPECK 48/96 block cipher can be used for blocks that are 6 bytes in length, and the SPECK 64/218 block cipher can be used for blocks that are 8 bytes in length. When no block ciphers are available for a particular block length, other encoding techniques, such as Feistel, can be used to create an invertible transform for those block sizes.

Additionally and/or alternatively, a simple lookup table can be used to transform blocks. FIG. 15 is a flowchart of an example process 1500 for iteratively attempting to decode ciphertext with different counter values. The example process 1500 can be performed by any of a variety of controllers, such as the ECUs described above with regard to FIGS. 13 and 14.

A ciphertext message can be received (1502) and can be used to generate a corresponding cleartext message using a counter (1504). For example, the ciphertext 1412 can be received by the recipient ECU, as depicted in FIG. 14, and used to generate a cleartext message through decoding the ciphertext 1412 to obtain a randomized message 1410 (1415), generating a pseudo-random counter value 1408 (1409), and combining the pseudo-random counter value 1408 and the randomized message 1410 (1411) to generate the cleartext message 1401. The redundancy in the cleartext can be validated (1506), similar to the description above with regard to the validation 1424. If the cleartext is valid, then the cleartext message can be used by the controller (1508), similar to the description above with regard to 1426. If the cleartext is invalid, then a determination can be made as to whether to retry generating the cleartext value from the ciphertext using a different counter value (1510). For example, the controller may limit the number of times different counter values are tried (e.g., 1 attempt, 2 attempts, 3 attempts, etc.), and so this determination may be a check on whether that threshold number of attempts has been reached. If the threshold number of attempts has not yet been reached for the message, then the counter can be incremented (1512) and the cleartext can be generated again using the incremented counter value (1504) and the redundancy of the cleartext can again be determined (1506). If the threshold number of attempts has been reached without the cleartext message being successfully validated, then the message can be dropped and/or an alert can be generated (1514), similar to the description above with regard to 1428.

FIG. 16 is a flowchart of an example of a process 1600 for encoding and decoding data. As is shown, the process 1600 is a process for symmetric encoding and decoding of data, and is an example of a Fiestel cipher, as described above with regard to FIG. 14. For instance, referring to the example in FIG. 14, the process 1600 can be used as the cipher process for messages of 2 bytes, 3 bytes, 5 bytes, 6 bytes, and 7 bytes (and/or messages of other lengths). Other applications of the process 1600 to messages of other data lengths are also possible. The data, in the form of cleartext, can be processed in the encode 1602 direction (down, here) to generate corresponding ciphertext. Similarly, the ciphertext can be processed in the decode 1604 direction (up, here) to generate corresponding cleartext. Assuming the same cryptography key is used to both encode 1602 and decode 1604, a cleartext can be encoded 1602 and then decoded 1604. This is useful, for example, because this can allow a transmitting ECU to encoded cleartext message (e.g., cleartext message 201 or randomized message 210) for transmission as ciphertext. Then, for reception, a receiving ECU can receive the ciphertext and decode it to form the cleartext message. While the example process 1600 depicts three rounds of logical operators to generate the ciphertext, additional rounds of logical operators could also be used. For example, four or more rounds of logical operators can provide additional security.

In the process 1600 a cleartext is broken up into a first half block of cleartext 1606 and a second half block of cleartext 1608. For example, if the cleartext is two bytes (aka, sixteen bits), the first half block 1606 is the first eight bits and the second half block 1608 is the second eight bits. In another example, if the cleartext is five bytes (aka forty bits), each half block 1606 and 1608 is twenty bits.

In the process 1600 a ciphertext is broken up into a first half block of ciphertext 1610 and a second half block of ciphertext 1608. For example, if the cleartext is two bytes (aka, sixteen bits), the first half block 1606 is the first eight bits and the second half block 1608 is the second eight bits. In another example, if the cleartext is five bytes (aka forty bits), each half block 1606 and 1608 is twenty bits.

When using the process 1600 for encoding 1602, the cleartext is split into the first half block 1606 and the second half block 1608. The output of the cryptography 1602, the first half block of ciphertext 1610 and the second half block of the ciphertext 1612, can then be merged in order to create the final ciphertext.

When using the process 1600 for decoding 1604, the ciphertext is split into the first half block 1601 and the second half block 1612. The output of the decoding 1604, the first half block of cleartext 1606 and the second half block of the cleartext 1608, can then be merged in order to create the final cleartext.

The process 1614 includes three XOR operations 1614 and three PRF operations 1616. The particular PRF operation 1616 may be selected from a plurality of possible PRF operations. For example, as shown in FIG. 3, an ECU may select a PRF operation based on the data length of a message to be processed by the process 1600. For example, a data length of two or three bytes may result in an ECU selecting a lookup table for the process 1600. A data length of five, six, or seven bytes may result in an ECU selecting SPECK 32/64 for the process 1600.

FIG. 17 is a swimlane diagram of an example process 1700 used to encode and decode data communicated over a CAN bus. The process 1700 can be performed by, for example, a transmitting ECU 1702 that can communicate over a CAN bus 1704 with a receiving ECU 1706. To harden the communications over the CAN bus 1704, the transmitting ECU 1702 and the receiving ECU 1706 can communicate with encoded data. For example, the two ECUs 1702 and 1706 can both be configured to use the same cryptography scheme and cryptography keys, allowing them to privately access the cleartext of enciphered data. Some of these operations that are depicted in series in process 1700 may additionally and/or alternatively, be performed in parallel with each other.

The transmitting ECU 1702 can accept a cleartext message to be transmitted to the receiving ECU 1706, the cleartext message having one to a particular number of bytes of information 1708. For example, the normal operations of the transmitting ECU 1702 can result in the generation of a message that should be sent to the receiving ECU 1706, and the transmitting ECU 1702 can receive the cleartext message for such a communication. In another example, the transmitting ECU may be an access point for the CAN bus 1704 through which a message to the receiving ECU 1706 is routed. In such a case, the transmitting ECU 1702 can receive the cleartext message in order to prepare to route the information to the receiving ECU 1706.

In one example, the transmitting ECU 1702 may be responsible for monitoring the operating temperature of an engine in an automobile. When the transmitting ECU 1702 detects an abnormally high engine temperature, the transmitting ECU 1702 can receive a four-byte cleartext message that should be sent to a receiving ECU 1706 responsible for presenting information on the automobile's dashboard. This cleartext message can include instructions for the receiving ECU 1706 to illuminate a lamp indicating high engine temperature and to sound an alarm.

As described above with regard to FIG. 14, the cleartext message can include redundant data (e.g., redundant data 204), which can be compared against expected values for these message components (generated using one or more predetermined models for the message) to authenticate the message. As discussed above, these values can be predictable based on any of a variety of factors, such as a known previous message of the same type, and when they are determined to be within an acceptable range or distance of an expected values, can indicate that the message is authentic and not from a nefarious source (e.g., source spoofing identity of another ECU). For example, for a four-byte cleartext message of engine temperature, previous off-line testing of the vehicle may show that 143 bits of the four-byte message are predictable. In another example, testing of a home automation controller may indicate that a two-byte cleartext message identifying the current operating status of a corresponding home automation device (e.g., lock, sensor, camera, latch) includes several predictable bits throughout the message. Such predictable bits may be spread out through the message, they may or may not be contiguous, may be the leftmost or rightmost bits, etc.

However, as is shown here, the transmitting ECU 1702 may or may not explicitly identify which bits within the cleartext message are predictable. Instead, the receiving ECU 1706 can be preloaded with a model for identifying the predictable bits based on, for example, the message type (e.g., engine message type, home automation type message) that identifies the predictable (expected) values for these bits, which can be used to authenticate the message. The transmitting ECU 1702 can validate the redundancy in the message (1710) (for its message type) before encoding and transmitting the message over the CAN bus 1704. For example, the transmitting ECU 1702 can ensure that redundant data is present in the message that will permit the receiving ECU 1708 to authenticate the message. The transmitting ECU 1702 can access a model for the type of the message and can use the redundancy patterns (e.g., redundancy patterns 1420) included therein to validate the redundancy in the message.

Once the redundancy in the message has been validated, the transmitting ECU 1702 can generate a pseudo-random counter by applying a pseudorandom function to a counter value that is incremented for each cleartext message generated by the ECU (1712). For example, the transmitting ECU 1702 can keep a counter (e.g., counter 1406) that increments every time a new cleartext message of the message type is transmitted over the CAN bus 1704. The transmitting ECU 1702 can apply a PRF (e.g., PRF 1409) to the value of the counter that is associated with the cleartext message in order to generate a pseudo-random counter.

Examples of these pseudorandom functions include a block cipher, lookup table, a hash function, etc.

The transmitting ECU 1702 can combine the cleartext message and the pseudo-random counter to create a randomized message (1714). For example, the transmitting ECU 1702 can use, as input, the cleartext and the pseudo-random counter to a function that combines those two values to generate a randomized value, such as combining the cleartext message and the pseudo-random counter values using an XOR function.

The transmitting ECU 1702 can encode the randomized message to generate ciphertext (1716), which can then be transmitted over the CAN bus 1704 (1716). For example, the ECU 1702 can apply a block cipher to the randomized message using a key that is a shared secret between the transmitting ECU 1702 and the receiving ECU 1704. The transmitting ECU 1702 can then transmit, to the receiving ECU 1706 over the CAN bus 1706, the ciphertext (1718) in a message that include the message identifier in a header field.

The CAN bus 1704 can carry (1720) the ciphertext from the transmitting ECU 1702 to the receiving ECU 1706, and the receiving ECU 1706 can receive the ciphertext (1722). For example, the receiving ECU 1706 can listen on the CAN bus 1704 for any messages that contain the message identifier and pull in the message from the transmitting ECU 1702. The receiving ECU 1706 can decode the ciphertext into the randomized message (1724). The receiving ECU 1706 can use the same block cipher and key to decode the ciphertext as the transmitting ECU 1702 used to encode the message (1716). The receiving ECU 1706 can then generate the pseudo-random counter (1726), similar to the transmitting ECU 1702 (1712), and can combine the pseudo-random counter with the randomized message to generate a cleartext message (1728), such as through an XOR operation. The receiving ECU 1706 can then identify expected data values for redundancy in the cleartext message (1730), which can be based on the type for the message and corresponding redundancy patterns for that message type. The redundancy can then be validated (1732) and, if the redundancy is determined to be valid, the cleartext message can be accepted and delivered (1734). In contrast, if the redundancy in the cleartext message is determined to be invalid, then the receiving ECU 1706 can retry the authentication operations with an incremented counter (1736). The receiving ECU 1706 may retry the authentication operations up to a threshold number of times (e.g., retry 1 time, retry up to 2 times, retry up to 3 times, etc.) before dropping the message and generating an alert.

FIG. 18 is a flowchart of an example process 1800 used to validate/authenticate messages. In general, the process 1800 can be organized into a training time 1802 and an operating time 1804. The training time 1802 can include actions that are generally used to create validation classifiers (or models), while the operating time 1804 can include actions that are generally taken to validate cleartext messages.

Actions taken in the training time 1802 can be conducted by a handful of security researchers working with a new automobile in a clean environment cut off from any potential malicious actors or malicious data messages. The actions in the training time 1802 may be performed to learn about a particular automobile's messaging scheme in order to understand how validators should be structured, or in order to generate validators (e.g., message models). Additionally or alternatively, actions in the training time 1802 can be undertaken by designers of an automobile to be protected. That is, designers of an automobile may, as part of designing the automobile or after completing design of the automobile, use their knowledge of the automobile design in order to generate or design validators.

Actions taken in the operating time 1804 can be conducted by ECUs within an automobile as part of the normal function of the automobile. That is, after a validator or set of validators (e.g., message models) is loaded into a receiving ECU, the receiving ECU may use the validators as part of receiving a message from other ECUs in an automobile. As will be understood, the training time 1802 and operating time 1804 may overlap. For example, an automobile may be loaded with a validator (e.g., message model) for use while driving in operating time 1804. Later, further training time 1802 testing may result in a computationally more efficient validator that is then loaded onto the automobile for further use in the operating time 1804.

An automobile is actuated 1806. For example, a technician can start the engine of the automobile, open or close a door, or otherwise engage a part of an automobile that will cause an ECU in the automobile to generate a new message. In some cases, a sensor can be spoofed instead of actuating a physical part of the automobile. For example, a contact sensor designed to sense an open or closed trunk can be manually actuated directly, or a sensor can be replaced with a computer-controlled voltage controller that simulates an open or closed sensor.

Messages are collected 1808. For example, the CAN bus of the automobile can be monitored to watch for new messages generated by the ECUs of the automobile. These messages may be collected and stored in computer readable memory for later analysis, along with metadata about the message (e.g., a timestamp, parameters reflecting the status of the automobile when the message was collected).

A validator or model is generated 1810. For example, a plurality of the messages may be analyzed in order to design one or more validators (models) that can be used to validate and invalidate messaged created during the operating time. Models can be generated for message payload and/or redundant data within particular message types (e.g., message ids) based the observed messaging behavior within the training environment 1802.

Some example validators (e.g., models) include identifying predictable data within cleartext of messages. To identify predictable data, a sequence of the same kinds of messages are identified and analyzed. From this analysis, one or more rules are generated that include comparing a new message to a previous message and determining if the predictable data within the new message is actually within the predicted range given the previous message. One type of validation test includes finding the Hamming distance between the predictable data of a previous message with the predictable data of a current message.

Generally speaking, Hamming distance between two strings of equal length includes finding the number of positions at which the corresponding symbols (e.g., bit values) are different. This may be described as finding the minimum number of substitutions required to change from the previous message to the current message. If the Hamming distance is found to be less than a threshold value determined from analysis of the sequence of messages, the new message can be validated (authenticated).

One type of validation test includes finding the Euclidean distance between the predictable data of a previous message with the predictable data of the current message.

Generally speaking, Euclidean distance between two strings of equal length includes mapping the previous message and the current message to points in N-dimensional space, where N is the dimensionality of the predictable data, and finding the distance of the shortest line segment between those two points. If the Euclidean distance is found to be less than a threshold value determined from analysis of the sequence of messages, the new message can be validated.

One type of validation test includes use of machine learning to generate one or more classifiers that is able to classify a new message given a previous message. For example, a machine-learning engine can perform one or more machine learning processes on the sequence of messages as training data. This engine can generate computer code that takes, as input, a previous message and a current message. The computer code then classifies the new message as either valid or invalid given the previous message.

In many cases, ECUs in an automobile generate many different kinds of messages. In such cases, the operations 1806-1810 can be used to generate many different validators (e.g., models), including at least one validator (e.g., model) for each type of message possible.

A new message is received 1812. For example, the validator or validators (e.g., modles) generated 1810 can be installed in a new car or as an after-market upgrade. As the automobile is used (e.g., driven), the ECUs in the automobile generate messages to other ECUs for control of the automobile. A receiving ECU can receive messages generated by sending ECUs as part of their control operations for the automobile. In another example, the validator or validators generated 1810 can be installed in new home automation controllers in a smart home environment, and/or added as an after-market upgrades. Messages can be transmitted among such home automation controllers to provide monitoring information (which can indirectly be used to perform control operations) and/or to control operation of devices that are managed by the controllers, such as lighting, doors, locks, HVAC equipment, appliances, security systems, and/or other components.

The new message is validated (authenticated) with the validator 1814. For example, the receiving ECU can supply the new message to the validator along with the previous message of the same type. In cases in which a plurality of validators (e.g., models) are available, the receiving ECU can select the validator from the available validators. This selection may be based on, for example, the type of message that is to be validated (authenticated).

If the message is validated by the validator (e.g., model), the message is accepted 1816. For example, the receiving ECU may store the received message as the most recent message and may operate on the received message. For example, if the received message is an engine temperature message, the receiving ECU may update the dashboard display with the new engine temperature.

If the message is not able to be authenticated, the message is rejected 1818. For example, the receiving ECU may discard the message, may enter a heightened security mode, increment a counter indicating messages that are unable to authenticated, and/or may communicate its inability to authenticate a message as an indication of malicious activity.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

FIG. 7 is a graphic user interface (GUI) showing data produced by the technology described in this document. As shown here, a dashboard of attacks on images and ECUs can be visualized for a viewer.

What is claimed is:

1-20. (canceled)

21. A non-transitory computer readable medium including instructions that, when executed by at least one processor, cause the at least one processor to perform operations for two-factor validation for computer-assisted vehicle functions, comprising:
receiving, from a real time sensor in a vehicle, sensor data collected by the sensor during operation of the vehicle and relating to a sensed environmental characteristic;
identifying a potential computer-assisted vehicle function to be performed in the vehicle based on the sensor data;
accessing, before the potential computer-assisted vehicle function is allowed to occur, a source of validation information external to the vehicle, wherein the source of validation information also relates to the environmental characteristic; and
determining whether the sensed environmental characteristic corresponds to the validation information; and
based on the determining, either:
permitting the computer-assisted vehicle function to occur when the sensed environmental characteristic corresponds to the validation information; or
sending a report to a reporting service when the sensed environmental characteristic does not correspond to the validation information.

22. The non-transitory computer readable medium of claim 21, wherein the sensed environmental characteristic is a detected object.

23. The non-transitory computer readable medium of claim 21, wherein the sensed environmental characteristic is a detected road sign.

24. The non-transitory computer readable medium of claim 21, wherein the sensed environmental characteristic is a detected landmark.

25. The non-transitory computer readable medium of claim 21, wherein the sensed environmental characteristic is a speed limit associated with GPS information associated with the vehicle.

26. The non-transitory computer readable medium of claim 21, wherein the sensed environmental characteristic is a color of a traffic signal.

27. The non-transitory computer readable medium of claim 21, wherein the potential computer-assisted vehicle function is braking the vehicle.

28. The non-transitory computer readable medium of claim 21, wherein the source of authentication information is a map database.

29. The non-transitory computer readable medium of claim 21, wherein the report is configured to update a confidence parameter associated with the potential computer-assisted vehicle function.

30. The non-transitory computer readable medium of claim 21, wherein the report is configured to update a confidence parameter associated with the source of validation information.

31. A computer-implemented method for two-factor validation for computer-assisted vehicle functions, the method comprising:
receiving, from a real time sensor in a vehicle, sensor data collected by the sensor during operation of the vehicle and relating to a sensed environmental characteristic;
identifying a potential computer-assisted vehicle function to be performed in the vehicle based on the sensor data;
accessing, before the potential computer-assisted vehicle function is allowed to occur, a source of validation information external to the vehicle, wherein the source of validation information also relates to the environmental characteristic; and
determining whether the sensed environmental characteristic corresponds to the validation information; and
based on the determining, either:
permitting the computer-assisted vehicle function to occur when the sensed environmental characteristic corresponds to the validation information; or
sending a report to a reporting service when the sensed environmental characteristic does not correspond to the validation information.

32. The computer-implemented method of claim 31, wherein the sensed environmental characteristic is a detected object.

33. The computer-implemented method of claim 31, wherein the sensed environmental characteristic is a detected road sign.

34. The computer-implemented method of claim 31, wherein the sensed environmental characteristic is a detected landmark.

35. The computer-implemented method of claim 31, wherein the sensed environmental characteristic is a speed limit associated with GPS information associated with the vehicle.

36. The computer-implemented method of claim 31, wherein the sensed environmental characteristic is a color of a traffic signal.

37. The computer-implemented method of claim 31, wherein the potential computer-assisted vehicle function is braking the vehicle.

38. The computer-implemented method of claim 31, wherein the source of authentication information is a map database.

39. The computer-implemented method of claim 31, wherein the report is configured to update a confidence parameter associated with the potential computer-assisted vehicle function.

40. The computer-implemented method of claim 31, wherein the report is configured to update a confidence parameter associated with the source of validation information.
